(19) United States
(12) Patent Application Publication
(10) Pub. No.: US 2025/0265907 A1
(43) Pub. Date: Aug. 21, 2025

(54) PULLTAB GAMING

(71) Applicant: USA Pulltabs LLC, River Falls, WI (US)

(72) Inventors: Anna SCHMITZ, Vadnais Heights, MN (US); Andrew SCHMITZ, Vadnais Heights, MN (US)

(73) Assignee: USA Pulltabs LLC, River Falls, WI (US)

(21) Appl. No.: 19/043,244

(22) Filed: Jan. 31, 2025

Related U.S. Application Data
(63) Continuation-in-part of application No. 18/774,631, filed on Jul. 16, 2024.
Application No. 18/774,631 is a continuation-in-part of application No. 18/605,766, filed on Mar. 14, 2024.
(60) Provisional application No. 63/554,909, filed on Feb. 16, 2024.

(51) Int. Cl. G07F 17/32; G06K 7/14

(52) U.S. Cl. CPC G07F 17/329; G06K 7/1417; G07F 17/3223; G07F 17/3241; G07F 17/3246

(57) ABSTRACT

A prize-redemption device is configured to: receive, from a remote computing system, a set of game data for a pulltab game comprising a plurality of pulltab cards to exclusively pair the pulltab game with the prize-redemption device; scan a scannable prize-verification code on one of the plurality of pulltab cards; verify the pulltab card as a winning card by determining, based on the prize-verification code and the game data, that the pulltab game is paired with the prize-redemption device and/or activated for redemption on the device, and that the pulltab card has not already been redeemed; and, in response to verifying the pulltab card, dispensing a cash prize associated with the pulltab card.

### PRIORITY CLAIM

This U.S. Non-Provisional Utility Patent Application is a continuation-in-part of:
U.S. Non-Provisional Utility patent application Ser. No. 18/774,631, filed on Jul. 16, 2024, and entitled “PULLTAB GAMING,” which is a continuation-in-part of:
U.S. Non-Provisional Utility patent application Ser. No. 18/605,766, filed on Mar. 14, 2024, and entitled “PULLTAB GAMING,” which claims the priority benefit of:
U.S. Provisional Patent Application No. 63/554,909, filed on Feb. 16, 2024, and entitled “PULLTAB GAMING,” to which:
U.S. Non-Provisional Design patent application Ser. No. 29/934,702, filed on Mar. 27, 2024, and entitled “PULLTAB CARDS” also claims priority.
   The entire contents of each of these applications are hereby incorporated by reference.

### FIELD OF TECHNOLOGY

The present disclosure generally relates to card-based games and lottery-type games, including collectible trading cards and pulltab games.

### BACKGROUND

“Pulltabs” (or “pull-tabs”) is an incredibly popular lottery-type game played in bars, pubs, breweries, and restaurants throughout the world. Known also by the names “pop-opens,” “break-opens,” and “pickle cards,” pulltabs involves a set of small cardboard cards (or “tickets”) available for purchase by customers of the hosting establishment. Often, a ticket booth staffed by a designated vendor (or “game operator”) manages sales of the cards, however, bartenders or other employees of the establishment can run the game as well. Typical pulltab cards include two or more cardboard layers coupled together-a bottom layer, featuring one or more randomized gaming entries; and a perforated top layer adhered overtop of the bottom layer to initially conceal the gaming entries. After purchase, the player can rip open a set of perforated strips (or “tabs”) on the top layer of the card in order to reveal the gaming entry concealed underneath. Upon revealing a “winning” gaming entry, the player can return the opened card to the vendor in exchange for a cash prize.

### SUMMARY OF THE INVENTION

Disclosed herein are various example systems, devices, and methods for automating certain aspects of a pulltab game, including enhanced security measures to help preserve the integrity of the game.

In some examples, a pulltab-game system includes: a vending machine configured to retain and dispense a set of pulltab cards of a pulltab game; and a prize-redemption device configured to: scan a scannable code displayed on a pulltab card from the set of pulltab cards; determine, based on the scannable code, a prize-verification code for the pulltab card; verify, based on the prize-verification code, that the pulltab game to which the pulltab card belongs is paired with the prize-redemption device and/or activated for redemption on the prize-redemption device; identify, based on the prize-verification code, the pulltab card as a winning card; confirm, based on the prize-verification code, that the winning card has not already been redeemed; and output, based on the prize-verification code, a cash prize associated with the pulltab card or an indication of the cash prize. In some such examples, the prize-redemption device is further configured to collect and retain the pulltab card.

In some examples, a prize-redemption device of a pulltab-game system includes: a scanner configured to scan a scannable code printed under a perforated tab on a pulltab card of a pulltab game; and processing circuitry configured to: determine, based on the scannable code, a prize-verification code for the pulltab card; verify, based on the prize-verification code, that the pulltab game is paired with the prize-redemption device and/or activated for redemption on the prize-redemption device; identify, based on the prize-verification code, the pulltab card as a winning card; confirm, based on the prize-verification code, that the winning card has not already been redeemed; and cause the prize-redemption device to output, based on the prize-verification code, a cash prize associated with the pulltab card or an indication of the cash prize. In some such examples, the processing circuitry is further configured to cause the prize-redemption device to collect and retain the pulltab card.

In some examples, a non-transitory, computer-readable medium encodes program instructions that, when executed by a processor of a prize-redemption device, cause the processor to: receive scan data indicative of a scannable code printed on a pulltab card of a pulltab game; determine, based on the scan data, a prize-verification code for the pulltab card; verify, based on the prize-verification code, that the pulltab game to which the pulltab card belongs is paired with the prize-redemption device and/or activated for redemption on the prize-verification device; identify, based on the prize-verification code, the pulltab card as a winning card; confirm, based on the prize-verification code, that the winning card has not already been redeemed; and cause the prize-redemption device to output, based on the prize-verification code, a cash prize associated with the pulltab card or an indication of the cash prize. In some such examples, the instructions further cause the processor to cause the prize-redemption device to collect and retain the pulltab card.

The aspects, features, advantages, benefits, and objects of the invention will become clear to those skilled in the art by reference to the following description, claims and drawings.

### BRIEF DESCRIPTION OF THE DRAWINGS

FIG. 1 is a conceptual diagram of an automated pulltab-game system, in accordance with techniques of this disclosure.

FIG. 2 is a conceptual diagram of a portion of the pulltab-game system of FIG. 1, showing some example components thereof.

FIG. 3 is a perspective view of an example pulltab-card vending machine of the system of FIG. 2.

FIG. 4A is a front view of an example collectible pulltab card from the system of FIGS. 1 and 2.

FIG. 4B is a back view or rear view of the collectible pulltab card of FIG. 4A, having a set of perforated tabs in a “sealed” or “closed” configuration.

FIG. 4C is a back view of the pulltab card of FIGS. 4A and 4B, with its perforated tabs in an “unsealed” or “open” configuration.

FIG. 5A is a front view of a first example prize-redemption device for the system of FIG. 2.

FIG. 5B is a front view of another example of the prize-redemption device of FIG. 5A.

FIG. 6 is a front view or proximal-end view of an example ticket collector for the prize-redemption device of FIG. 5B.

FIG. 7 is a perspective view of a second example prize-redemption device for the system of FIG. 2.

FIG. 8 is a front view of a third example prize-redemption device for the system of FIG. 2.

FIG. 9A is a spreadsheet depicting a first example set of pulltab-game data for the system of FIG. 2.

FIG. 9B is a spreadsheet depicting a second example set of pulltab-game data for the system of FIG. 2.

FIG. 10 is a conceptual block diagram of an example central computing system of the pulltab-game system of FIG. 2.

FIG. 11A is a screenshot of an example graphical user interface (GUI) of a website run by the central computing system of FIGS. 2 and 10.

FIG. 11B is a screenshot of an example GUI of a customized Customer-Relationship Management (“CRM”) software application run by the central computer of FIGS. 2 and 10.

FIGS. 12A-12L are screenshots of example GUIs of the CRM application of FIG. 11B.

FIG. 13 is a screenshot of another example GUI of the CRM application of FIG. 11B.

FIG. 14 is a flowchart illustrating a method of running an automatic pulltab game.

### DETAILED DESCRIPTION

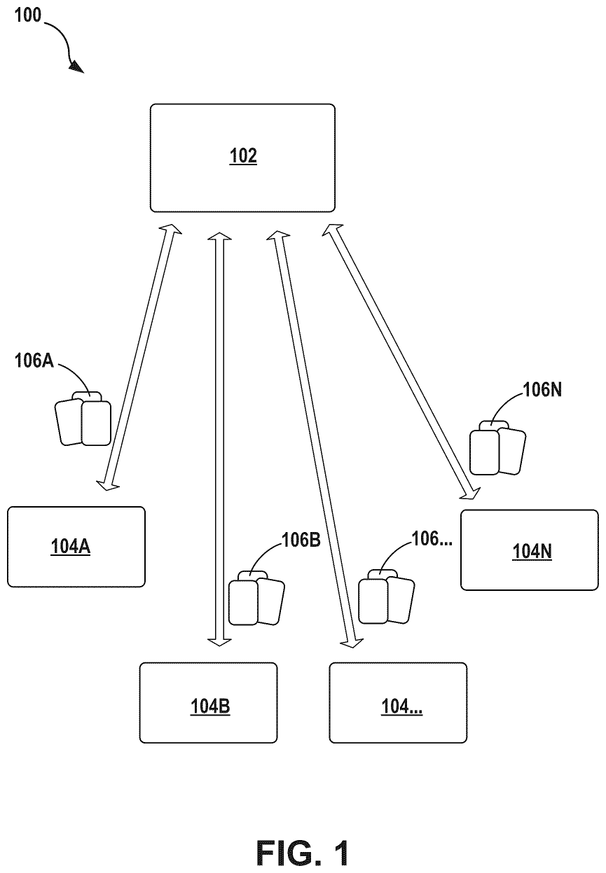

In general, the present disclosure is directed to systems, devices, and techniques for automating one or more aspects of a pulltab game and, by extension, managing an expanded network of pulltab games all running concurrently, thereby enabling the games to be played significantly faster, cheaper, more accurately, more securely, and efficiently scaled to a wider audience. For instance, FIG. 1 is a conceptual diagram of an example automatic pulltab-game system 100, in accordance with the techniques of this disclosure. As illustrated in FIG. 1, system 100 includes a central manager 102, and a plurality of game-hosting establishments 104A . . . 104N, such as bars, pubs, restaurants, gas stations, grocery stores, and the like.

Upon request by operators of the hosting establishments 104, central manager 102 provides the establishments 104 with sets of specialized, collectible pulltab cards 106 such that the operators may host the pulltab games within their establishments 104.

As described herein, central manager 102 manages one or more additional aspects of the pulltab games, such that, from the perspective of the hosting establishments 104, the games are at least partially (and in some examples, fully) automated. Of particular note among the novel features detailed below is the integration of additional security features to ensure the integrity of the game.

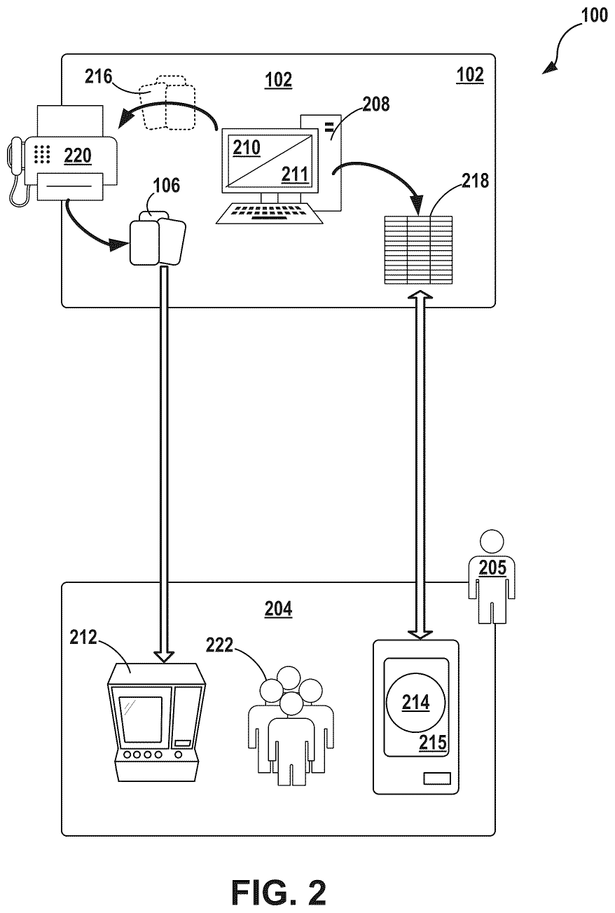

FIG. 2 is a conceptual diagram of a portion of system 100 of FIG. 1, specifically, illustrating an example relationship between central manager 102 and a hosting establishment 204 (e.g., any one of establishments 104 of FIG. 1). As illustrated in FIG. 2, central manager 102 includes a computer network 208 (or simply, “computer 208”) configured to execute a uniquely tailored Customer-Relationship Management (“CRM”) software application 210. System 100 further includes a card-vending machine 212 and a prize-redemption device 214, both located within the premises of the hosting establishment 204. In some examples (but not all examples), the vending machine 212 and the prize-redemption device 214 may be integrated within a shared housing, i.e., a single machine is configured with the functionality of both devices.

One example implementation of system 100 is as follows. An operator 205 associated with hosting establishment 204 uses CRM 210 to order a desired number of new pulltab games from central manager 102. For instance, the operator 205 can use a personal computing device, such as a smartphone, personal computer, laptop, tablet, or in some examples, the prize-redemption device 214, to remotely log into a secure portal with their private credentials to access CRM 210. Through CRM 210, the operator 205 can select from among a plurality of different “themes” categories of pulltab games, and order a desired number of games from each.

Upon receiving the order from operator 205, central computer 208 runs or executes a game-generator module 211 to generate the requested games. Specifically, for each new pulltab game within the order from operator 205, game-generator module 211 generates a set of graphical card images 216 and a counterpart set of game data 218. As detailed further below, graphical card images 216 and game data 218 collectively include a number of unique security features that enable players to enjoy the game with little-to-no intervention from operator 205, while simultaneously enhancing the game's integrity well beyond the current standard practices.

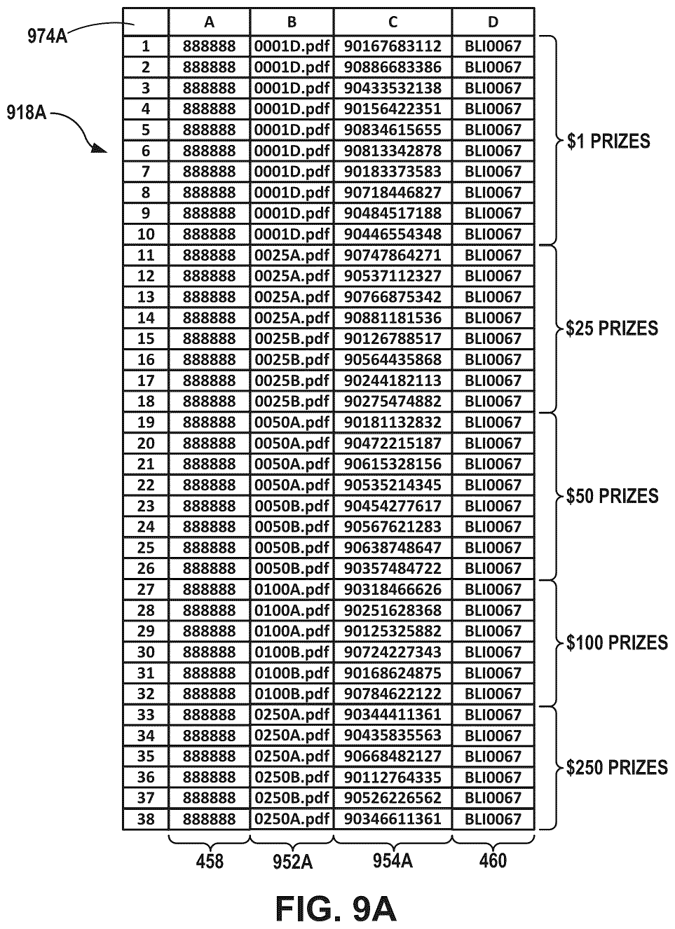

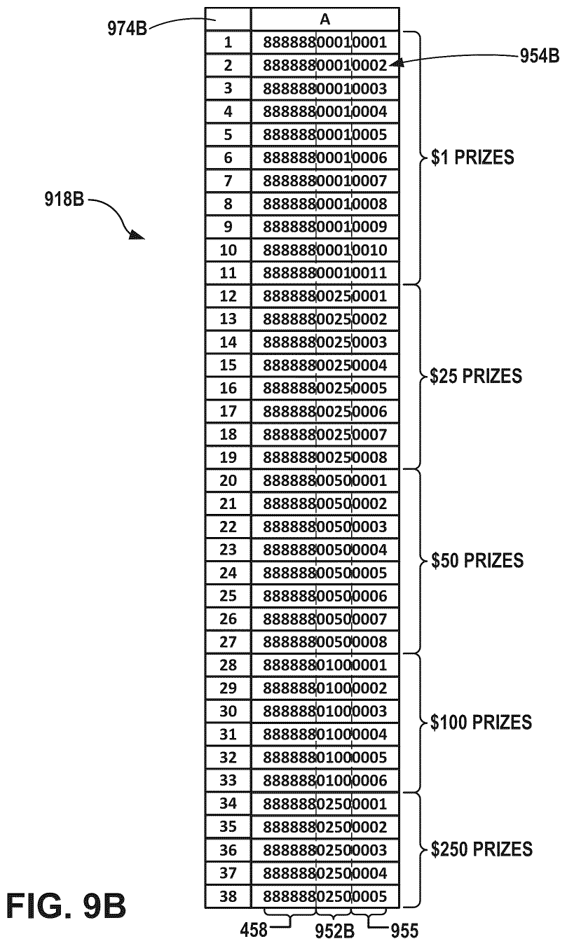

For instance, as detailed further below, game data 218 can include, for each winning pulltab card: a “game serial number” that indicates which pulltab game (which set of cards) the winning card belongs to; a “denomination code” that indicates an amount of prize money associated with the winning card; and either a “prize-verification code” or a “winning ticket ID,” both of which are used to distinguish between individual winning cards within the same gameset, through slightly different mechanisms (see FIGS. 9A & 9B).

After generating the graphical card images 216 and the counterpart game data 218, the central computer 208 transmits the graphical card images 216 to a pulltab-card printer 220 via any suitable data-communication conduit, whether wired (e.g., via a local-area network (LAN)) or wireless (e.g., email transmitted via Wi-Fi). Card printer 220 can range from a suitable single-printer device (e.g., a standard inkjet/toner printer), up to a designated mass-printing facility, capable of generating a complete set of physical pulltab cards 106 based on the graphical card images 216. In accordance with certain aspects of this disclosure, and as detailed further below, pulltab cards 106 may be constructed to provide dual gaming functionality, wherein a front side of each card corresponds to, for instance: a collectible trading-card game, a collectible game piece, or a coupon, and a back side of each card corresponds to the pulltab game. The set(s) of physical pulltab cards 106 are then shipped from the card printer 220 to the game-hosting establishment 204. Upon delivery to the game-hosting establishment 204, the operator 205 securely deposits the cards 106 within the pulltab-card vending machine 212.

In accordance with the techniques of this disclosure, prize-redemption device 214 is fitted with a custom operating system (OS) 215—i.e., program instructions stored in local memory and executed by a hard drive of the prize-redemption device 214—configured to securely interface with CRM 210 of computing system 208. Specifically, CRM 210 and OS 215 are configured to securely exchange data in order to “pair” a particular pulltab game (i.e., set of pulltab cards) with prize-redemption device 214, and/or to “activate” the pulltab game for redemption of prizes via device 214.

For instance, upon delivery of the pulltab cards 106 to the hosting establishment 204, CRM 210 receives an indication (from the game operator 205 and/or the shipping company) that delivery is complete (equivalently, that the cards' order is designated as “delivered”). In response, CRM 210 generates and displays a game-activation link. The game operator 205 can log-in to CRM 210 and access the game-activation link to “pair” the new sets of pulltab cards 106 with the prize-redemption device 214 located at establishment 204. That is, by using the game-activation link for a set of pulltab cards, the unique game serial number for that set of cards becomes eligible for redemption at just a single location 204, preventing that set's winning cards from being fraudulently redeemed multiple times at different locations.

In some such examples, the game-activation link comprises a clickable “Push Game Data to Prize-Redemption Device” button. In response to game operator 205 clicking this link, the CRM software 210 securely transmits game data 218, via an API call, to prize-redemption device 214. Prize-redemption device 214 receives the game data 218 and stores the data in a local digital memory (e.g., its hard drive).

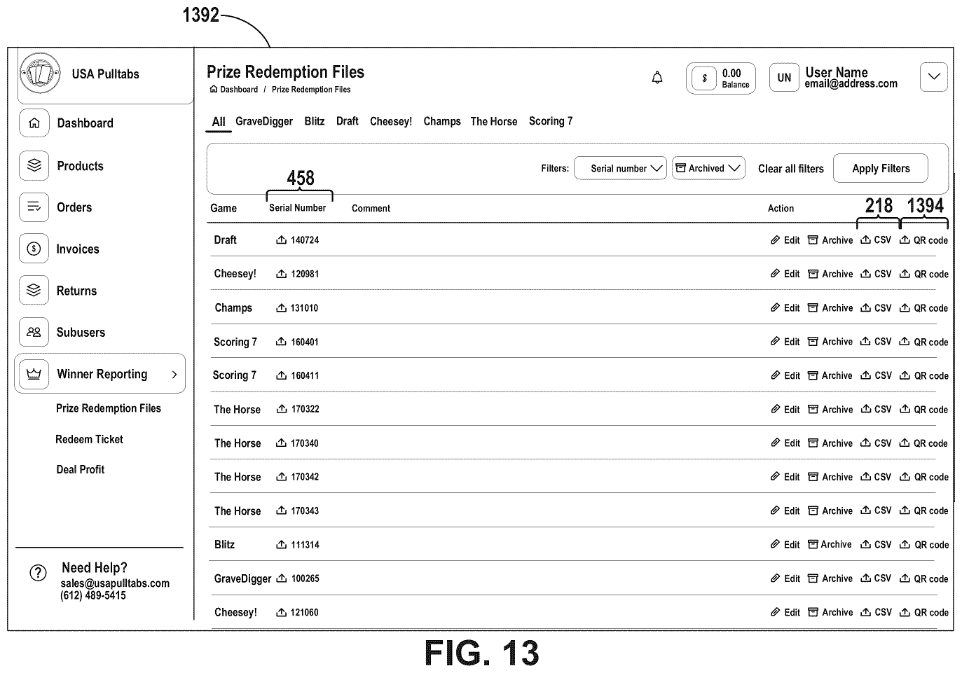

In other examples in which the operator 205 uses a mobile computing device (e.g., smartphone) to access CRM 210 and click the game-activation link, CRM 210 then displays a unique, scannable game-activation code, such as a quick-response (QR) code or barcode (see FIG. 13). The scannable activation code encodes: (1) a URL or API endpoint; (2) a unique game serial number for each new pulltab game (i.e., for each new set of cards); and (3) an authentication token or other secure credentials. The operator 205 can use an external optical code scanner of prize-redemption device 214 (detailed further below) to scan the activation code displayed on their mobile device. The prize-redemption device 214 extracts the URL and credentials from the activation code, and then makes a secure API request to the specified URL. CRM 210 receives the API request, and in response, securely transmits game data 218 via another API call, to prize-redemption device 214. Prize-redemption device 214 receives the game data 218 and stores the data in a local digital memory (e.g., its hard drive).

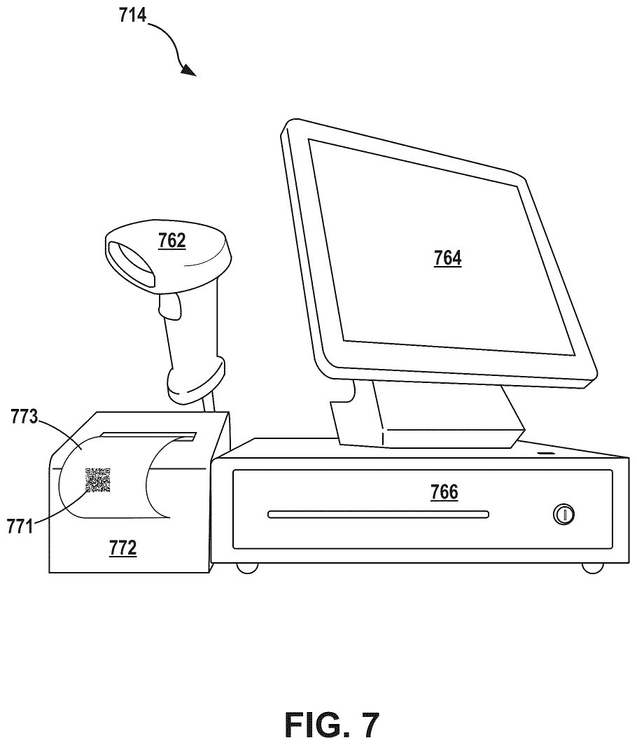

In other examples, operator 205 uses a personal computing device or point-of-sale (POS) terminal to access CRM 210 and click the game-activation link, CRM 210 then displays the unique scannable activation code, which the operator 205 can then print onto ticket-size paper or “sales receipt” paper (see FIG. 7). The operator 205 can then insert this paper ticket into an integrated ticket-collector-and-code-scanner of prize-redemption device 214 (detailed further below) to scan the activation code displayed on the paper. The prize-redemption device 214 extracts the URL and credentials from the activation code, and then makes a secure API request to the specified URL to download the game data 218 to a digital memory (e.g., hard drive) within the prize-redemption device 214.

In addition to, or instead of, pairing a pulltab game with a redemption device via wireless data transfer, in some cases, the operator 205 can manually upload the game data 218 into prize-redemption device 214, such as by inserting a USB flash drive, SD card, or other suitable removable digital storage volume, into the device 214, and copying the contents into the device's local memory.

In some examples, the newly “paired” pulltab game automatically becomes ready for active play (i.e., for redemption of prizes) immediately upon successful transfer of the game data 218 into the local memory of the prize-redemption device 214. In other examples, even after pairing the new pulltab game(s) with a particular prize-redemption device 214 (i.e., storing game data 218 within the local memory), the game(s) remain in a “dormant” status by default, until manually “activated” by the game operator 205. For instance, in some examples, upon pairing the game data 218 with the prize-redemption device 214, the graphical user interface (GUI) of the prize-redemption device 214 may then display a “Complete Activation,” “Confirm Activation,” or “Finalize Activation” prompt for the operator 205, thereby ensuring end-user control over the game-activation process with multiple layers of security integrated directly into the game.

In other examples, some or all of game data 218 is not stored locally within the digital memory of prize-redemption device 214 in advance of gameplay. Instead, prize-redemption device 214 can be configured to make on-demand calls to computing system 208 so that CRM 210 can remotely verify winning pulltab cards and transmit the results back to prize-verification 214 device to award the associated prizes. In some such examples, the game serial number may be paired with the prize-redemption device 214 for an initial verification check, while the rest of game data 218 is stored remotely in computing network 208.

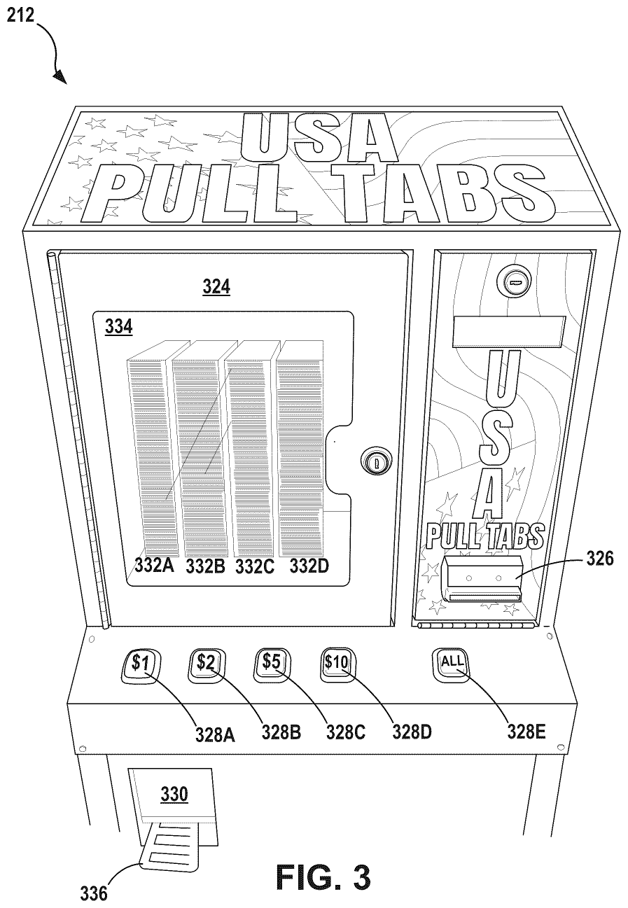

With the physical cards 106 secured within card-vending machine 212, with game data 218 (e.g., game serial numbers) paired with prize-redemption device 214, and (where applicable) with the game manually “activated” by the operator 205, players 222 can begin playing the pulltab games by interacting with card-vending machine 212. FIG. 3 shows an example implementation of vending machine 212 that includes a lockable card safe 324, a cash-deposit slot 326, a plurality of selectable buttons 328A-328E, and a pulltab-card-output slot 330.

In the illustrative, non-limiting example depicted in FIG. 3, lockable card safe 324 contains four columns or stacks 332A-332D of pulltab cards, as viewed through transparent window 334. Each column or stack 332 corresponds to one of four different pulltab games running simultaneously. For instance, stack 332A includes pulltab cards available for $1 each, as indicated by button 328A. Stack 332B includes pulltab cards available for $2 each, as indicated by button 328B. Stack 332C includes pulltab cards available for $5 each, as indicated by button 328C. And stack 332D includes pulltab cards available for $10 each, as indicated by button 328D. In other examples, lockable card safe 324 can retain pulltab cards from more, fewer, or different games. For instance, in a different example, columns 332A and 332B could include pulltab cards from the same game, in which case buttons 328A and 328B would display the same dollar amount for purchase.

During use, a player 222 (FIG. 2) initiates a transaction by depositing cash into the cash-deposit slot 326. Upon receiving cash through cash-deposit slot 326, one or more of buttons 328A-328D may be configured to illuminate, indicating which stacks 332 of pulltab cards the player 222 can select from. For instance, if the player 222 deposited $5, then buttons 328A, 328B, and 328C would illuminate, but not button 328D, as the player 222 did not deposit enough cash to purchase a $10 pulltab card from stack 332D. In that case, the player 222 can select from any combination of buttons 328A-328C to purchase a number of pulltab cards collectively adding up to $5. As a few examples, the player 222 could select button 328A five times; or the player could select button 328A three times and button 328B one time; or the player 222 could select button 328C one time.

Vending machine 212 also includes an “ALL” button 328E. By selecting this button, the player 222 indicates to vending machine 212 that they would like to select “all” of their cards from a common stack 332. For instance, rather than pressing button 328A five times in a row, the player 222 could press the “ALL” button 328E, and then press button 328A, and vending machine 212 will automatically begin grabbing pulltab cards drawn from stack 332A, and dispensing each pulltab card 336 outward through card-output slot 330, until either (1) the player's cash deposit is spent, or (2) the player 222 aborts the dispensing by pressing a different button 328. Other examples of vending machine 212 can include additional and/or different types of user-input devices other than pressable buttons 328, such as a digital touchscreen, a joystick, a scroll wheel, or any other suitable mechanism for indicating the player's card-stack selection to vending machine 212.

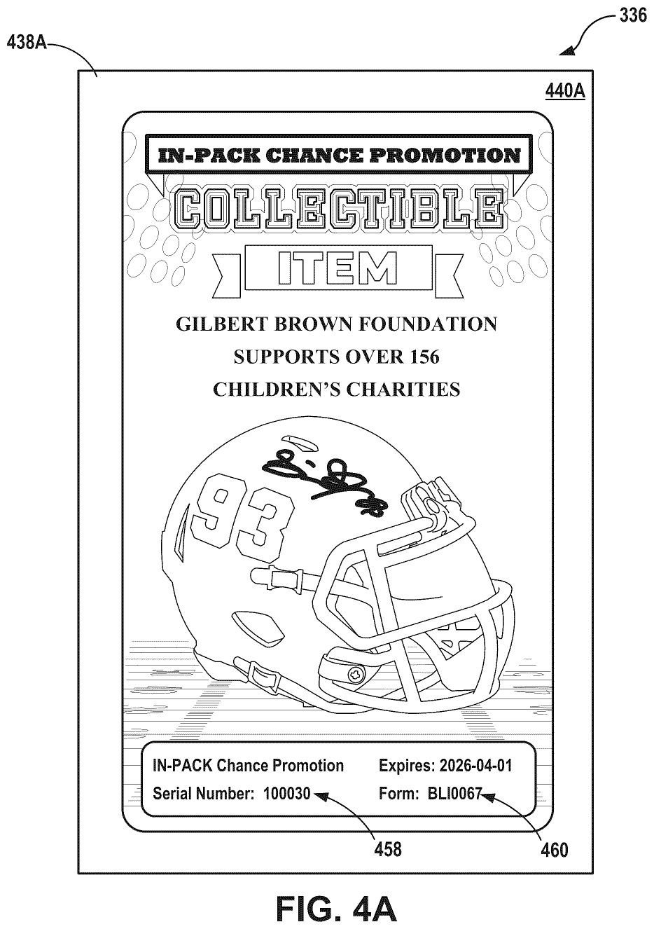

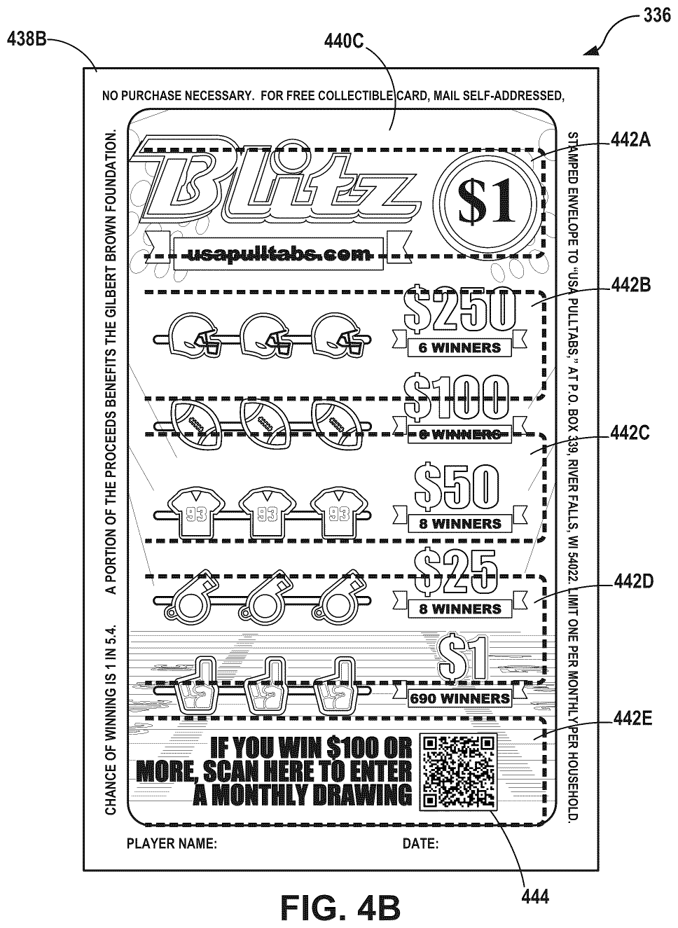

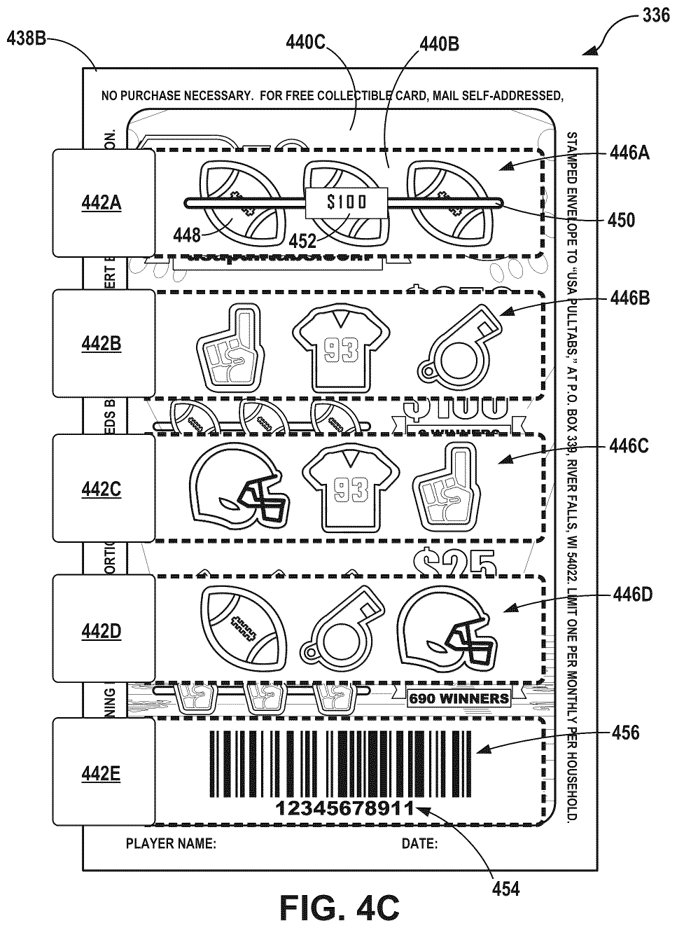

FIGS. 4A-4C depict an illustrative, non-limiting example of a pulltab card 336 (FIG. 3) that may be dispensed from vending machine 212. Pulltab card 336 of FIGS. 4A-4C is one example of such a card belonging to a larger set of pulltab cards 106 (FIG. 1) associated with a common pulltab game.

As referenced above, pulltab cards of the present disclosure can provide dual gaming functionality. For instance, as shown in FIG. 4A, a front side (or “first” side) 438A of pulltab card 336 corresponds to a collectible trading-card game, e.g., featuring graphical imagery associated with an athlete, an anime character, or any other suitable object that belongs to a larger collection of similar (but non-identical) objects.

Concurrently, as shown in FIGS. 4B and 4C, a back side (or “second” side) 438B of pulltab card 336 corresponds to a pulltab game, in accordance with system 100 described throughout this disclosure. Accordingly, in some examples of the present disclosure, each pulltab card 336 is formed from two layers of material (e.g., cardboard, or the functional equivalent). During manufacture of each card 336, printer 220 (FIG. 2) prints graphical imagery onto both surfaces 440A, 440B of a first cardboard layer, and onto just one surface 440C of the second cardboard layer, and then the two cardboard layers are adhesively assembled into the card 336. For instance, as depicted in FIG. 4A, a first printed surface 440A of a first cardboard layer constitutes the “collectible” front side 438A of the assembled pulltab card 336. As depicted in FIGS. 4B and 4C, the second surface 440B of the first cardboard layer, and the first surface 440C of the second cardboard layer, collectively form the “pulltab-game” back side 438B of the assembled card 336.

As shown in FIGS. 4B and 4C, the outer surface 440C of the second cardboard layer of pulltab card 336 defines one or more perforated tabs 442A-442E. In this non-limiting example, back-outer surface 440C defines five vertically aligned perforated tabs 442; other examples of pulltab card 336 can include more than five tabs or fewer than five tabs 442, as desired. As detailed further below, the back-outer surface 440C further includes an outer scannable code 444, such as a quick-response (“QR”) code, a barcode, or the like.

The second cardboard layer is adhered onto the back surface 440B of the first cardboard layer, such that back-inner surface 440B of the first cardboard layer and the back-outer surface 440C of the second cardboard layer face the same direction, i.e., opposite from the direction of the front surface 440A of the first cardboard layer.

In the example shown in FIG. 4C, the player 222 (FIG. 2) has ripped open all five perforated tabs 442A-442E of the second cardboard layer, thereby revealing certain portions of the printed back surface 440B of the first cardboard layer thereunder. Specifically, the printed back surface 440B of the first cardboard layer includes one or more pulltab-game entries 446A-446D, with each game entry 446 strategically positioned underneath a respective perforated tab 442A-442D of the second cardboard layer.

For instance, upon tearing open the first perforated tab 442A, the player 222 discovers that the game entry 446A concealed underneath the tab 442A includes a particular sequence of icons 448 (depicted here as three consecutive football-shaped icons 448), which, under the rules of the corresponding pulltab game, constitutes a winning game entry 446—thus, pulltab card 336 is a winning card.

At the time each pulltab game is originally generated, central computer 208 (FIG. 2) automatically identifies all of the winning game entries for that game, and graphically marks the winning game entries with a horizontal line 450 (which printer 220 prints onto the back surface 440B of the first cardboard layer), in order to simplify and expedite the game for player 222.

Additionally, upon generating a winning game entry 446A, computing device 208 determines a cash prize associated with the winning sequence of icons 448, and generates a numerical cash-prize indicator 452 (or “denomination indicator”) overtop of the winning game entry 446A (or, in other examples, overtop of a different (non-winning) game entry 446B-446D on the same card 336).

Even further, in accordance with the techniques of this disclosure, computing device 208, upon generating a winning game entry 446A, is configured to designate the winning card 336 with a unique identifier—a “prize-verification code”—thereby enabling automation of a subsequent portion of the game in which player 222 collects their cash prize. In FIG. 4C, the prize-verification code is printed onto the back surface 440B of the first cardboard layer and strategically concealed beneath the fifth perforated tab 442E, and includes both a numeric (or alphanumeric) prize-verification code 454, and an (inner) machine-scannable code 456, such as a barcode, QR code, etc., that digitally encodes the prize-verification code 454.

In the example shown, numeric prize-verification code 454 and scannable prize-verification code 456 occupy the space on the printed back surface 440B of the first cardboard layer that would otherwise be occupied by a fifth game entry. But since pulltab card 336 is already a winning card, game entries other than the winning game entry 446A are not necessary to be included on the same card.

Prize-verification code 454 is shown in FIG. 4C as an eleven-digit numeric sequence, although other sequences are also contemplated, such as a twelve-digit numeric sequence or a six-or-seven character alphanumeric sequence (as just three examples). In some examples, the prize-verification code 454 is mapped, within game data 218 (FIG. 2), to a distinct “game serial number” 458 (FIG. 4A) that indicates which pulltab game the card 336 belongs to upon generation of game data 218 by central computer 208 (see FIG. 9A).

In other examples, the prize-verification code 454 encoded by the scannable code 456 is a fourteen-digit numeric sequence in which game data 218 is represented by groups of adjacent digits. For instance, the first (i.e., left-most) six digits of the prize-verification code 454 can be the “game serial number” 458; the next (i.e., middle) four digits of the prize-verification code can be the “denomination code” indicating an amount of prize money; and the last (i.e., right-most) four digits of the prize-verification code 454 can be a “winning-ticket ID” used to distinguish between cards from the same gameset that also share the same denomination code (see FIG. 9B). That is, a single gameset may include multiple winning cards that award the same amount of prize money. Within each of these same-game-same-prize subsets, every winning card is assigned a different winning ticket ID (e.g., 0001, 0002, 0003, 0004, . . . ) to identify and track individual cards as they are redeemed, thereby preventing the same card from being redeemed more than once.

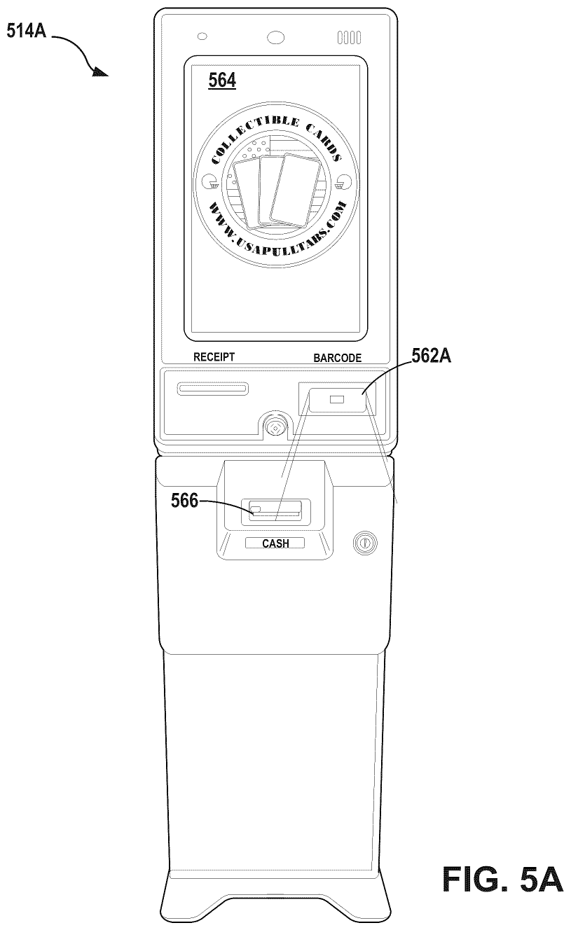

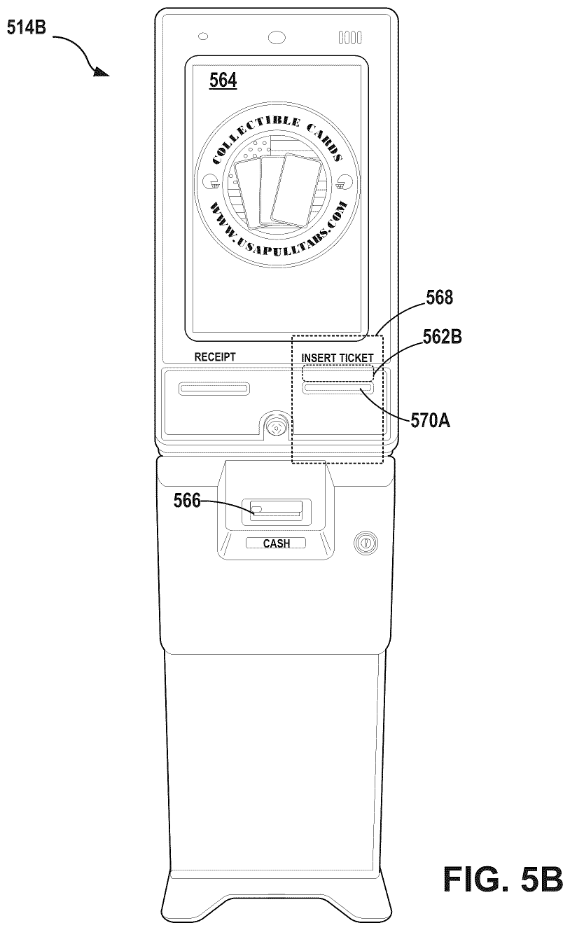

After tearing open the fifth perforated tab 442E to reveal the inner scannable code 456, the winning player 222 can then bring the winning card 336 to the local prize-redemption device 214 to verify the winning card 336 and claim their prize. FIGS. 5A, 5B, 7, and 8 depict some example implementations of prize-redemption device 214.

For instance, FIG. 5A is a front view of a first example prize-redemption device 514A in the form of a “kiosk” machine. As shown in FIG. 5A, prize-redemption kiosk 514A includes an integrated, exterior-facing (or “external”) code scanner 562A (i.e., an optical scanner, or the functional equivalent). As referenced above, the same external code scanner 562A can perform two separate functions. First, the game operator 205 can use the external code scanner 562A to scan an activation code that causes the kiosk 514A to wirelessly download the set of game data 218 for the current pulltab game, after which the operator 205 can manually “activate” or finalize activation of the game via the user interface 564. Second, the player 222 can use the external code scanner 562A to scan the scannable verification code 456 on their winning pulltab card 336.

Upon detecting a valid scannable code 456 (FIG. 4C) placed in front of the scanner 562A, prize-redemption kiosk 514A is configured to extract the numeric prize-verification code 454 encoded by the scannable code 456, and either (1) perform card verification locally by comparing the prize-verification code 454 to the game data 218 stored in its internal digital memory, or (2) transmit the prize-verification code 454 via the Internet to central computer network 208 (FIG. 2), whereby CRM 210 compares the code 454 to game data 218 and replies with a “valid” or “invalid” indication.

In accordance with the techniques of this disclosure, this advanced-security card-verification process includes the following steps: (1) identifying the pulltab card 336 as a “winning” card by locating the prize-verification code 454 (or winning-ticket ID) within the set of game data 218; (2) determining, based on the prize-verification code 454 and the game data 218, that the winning card has not already been redeemed (i.e., the associated cash prize has not already been awarded); and (3) determining, based on the game serial number 458, that the pulltab game (i.e., the set of pulltab cards) to which this card belongs is paired with this particular prize-redemption device kiosk 514A at this location and/or that the game operator 205 has manually activated (i.e., confirmed, completed, or finalized activation of) this set of pulltab cards for active play.

If every step of the verification process completes successfully, the prize-redemption kiosk 514A can identify the corresponding denomination code within game data 218 and then automatically dispense the indicated amount of prize money from cash dispenser 566.

Additionally, the prize-redemption device 514A (and/or CRM 210) then automatically modifies the game data 218 to prevent the same pulltab card 336 from being redeemed a second time. In some examples, the prize-redemption device 514A can add a “REDEEMED” indicator next to the relevant entry within game data 218, such that step (2) of the verification process will fail in the future. Equivalently, the prize-redemption device 514A can change an existing “UNREDEEMED” indicator within the game data 218 into a “REDEEMED” indicator. Alternatively, the prize-redemption device 514A can delete the winning card's entire entry from the game data 218, such that step (1) of the verification process will fail in the future. In these examples, step (2) of the verification process is the same as step (1), and thus, is performed simultaneously.

In some examples, the prize-redemption kiosk 514A (or any other prize-redemption device 214 of this disclosure) is configured to automatically log every prize-verification attempt (whether successful or unsuccessful) for subsequent auditing, reporting, and/or analysis. Similarly, the prize-redemption devices 214 of this disclosure may be configured to log every prize-redemption transaction (i.e., prize dispensing) for subsequent auditing, reporting, and/or analysis.

In some examples, prize-redemption kiosk 514A can include dual (or even higher-order) functionality. For instance, prize-redemption kiosk 514A can be fully functional as an automated teller machine (ATM), and/or a prize-redemption kiosk for other types of games, such as poker and other games of chance.

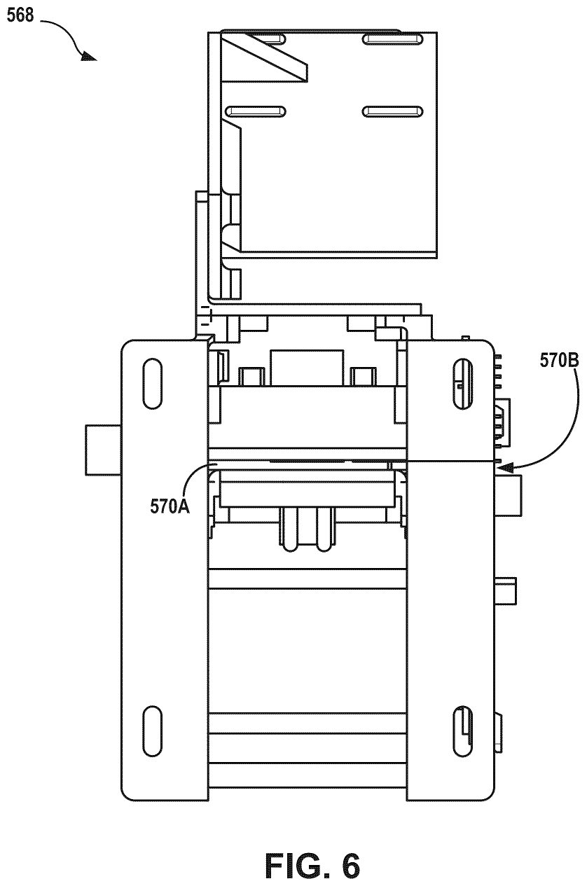

FIG. 5B depicts another prize-redemption kiosk 514B, which is an example of prize-redemption kiosk 514A of FIG. 5A, apart from any differences explicitly noted herein. In particular, unlike the external code scanner 562A of prize-redemption kiosk 514A, the optical code scanner 562B of prize-redemption kiosk 514B is an integral component of a mechanical ticket-collector-and-scanner 568 (for brevity, ticket collector 568) contained entirely within the housing of the kiosk 514B. A non-limiting example of ticket collector 568 is shown in FIG. 6A.

In general, ticket collector 568 is configured to intake, scan, and securely retain pulltab cards that have been purchased and played (i.e., that have had their tabs 442 opened). For instance, player 222 can insert their pulltab card 336 into the proximal (or “input”) slot 570A, whereby the internal code scanner 562B reads the scannable code 456 and and transmits the scan data to the primary hard drive of the kiosk 514B (or other relevant computing device) to determine the corresponding prize-verification code 454 for the pulltab card 336, and for subsequent verification based on the prize-verification code 454, as described above.

If the pulltab card 336 is successfully verified by the hard drive of the kiosk 514B, ticket collector 568 receives a corresponding digital acknowledgement signal from the hard drive and, in response, ticket collector 568 ejects the pulltab card 336 out the distal (or “rear”) output slot 570B, whereby the pulltab card 336 is securely retained within a receptacle fully interior to the kiosk 514B, i.e., where it cannot be retrieved by the player 222. Conversely, if the pulltab card 336 fails any step of the verification process described above, ticket collector 568 “rejects” the pulltab card by ejecting the card backward out through the proximal slot 570A.

FIG. 7 is a front perspective view of a third example prize-redemption device 214 in the form of a “point-of-sale” (“POS”) terminal 714. As shown in FIG. 7, POS 714 includes an integrated and/or handheld code scanner 762 (i.e., an optical scanner, or the functional equivalent). Upon detecting a valid scannable code 456 (FIG. 4C) placed in front of the scanner 762, POS 714 is configured to extract the prize-verification code 454 encoded by the scannable code 456, and either (1) verify the pulltab card locally using its internal processing circuitry (as described above), or (2) transmit the prize-verification code 454 via the Internet to central computer network 208 (FIG. 2), whereby CRM 210 verifies the card and replies with a “valid” or “invalid” indication.

Additionally or alternatively, POS 714 can include a user interface 764, such as a digital touchscreen displaying a graphical user interface (GUI), that enables player 222 to manually enter the prize-verification code 454 from the winning card 336. In some examples, when POS 714 identifies a match between the prize-verification code 454 and game data 218, POS 714 can indicate on display 764 an amount of prize money for the operator 205 to dispense from cash register 766. In other examples, POS 714 may print, from ticket printer 772, a paper ticket 773 with a scannable code 771 indicating an amount of prize money, in which case the player 222 can then use a separate machine (such as prize-redemption kiosks 514A/514B) to scan the paper ticket 773 and automatically dispense the corresponding cash prize. In either case, POS 714 is configured to automatically modify the game data 218 to prevent the same pulltab card from being redeemed a second time, as described above.

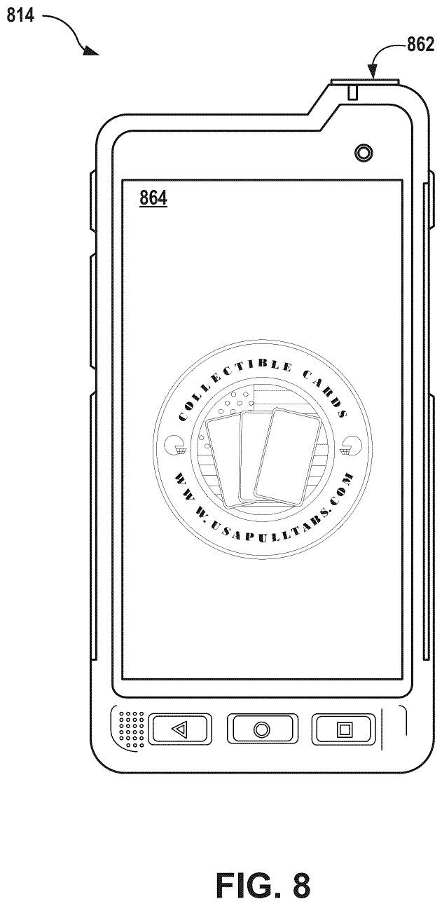

FIG. 8 is a front perspective view of a fourth example prize-redemption device 214 in the form of a mobile (or “handheld”) scanner device 814. Two non-limiting examples of such a device are the “Sonim Scan XP8” and the “Sonim Scan XP10” manufactured by Sonim Technologies, Inc., of San Diego, California.

As shown in FIG. 8, mobile scanner 814 includes an integrated code scanner 862 (i.e., an optical scanner, or the functional equivalent). Upon detecting a valid scannable code 456 (FIG. 4C) placed in front of the scanner 862, mobile scanner 814 is configured to extract the prize-verification code 454 encoded by the scannable code 456, and either (1) verify the pulltab card locally by comparing the prize-verification code 454 to game data 218 stored in the internal digital memory of mobile scanner 514C, or (2) transmit the prize-verification code 454 via the Internet to central computer network 208 (FIG. 2), whereby CRM 210 verifies the card and replies with a “valid” or “invalid” indication. Additionally or alternatively, mobile scanner 814 can include a user interface 864, such as a digital touchscreen displaying a graphical user interface (GUI), that enables an authorized game host to manually enter the prize-verification code 454 from the winning card 336.

In some examples, when mobile scanner 814 identifies a match between the prize-verification code 454 and game data 218, mobile scanner 814 can indicate on display 864 an amount of prize money for the authorized game host to provide to the player 222, such as from cash register 766 of FIG. 7. In other examples, mobile scanner 814 may print, from an integrated ticket printer (not shown) or from a physically distinct ticket printer 772 (FIG. 7), a paper ticket 773 with a scannable code indicating an amount of prize money, in which case the player 222 can then use a separate machine (such as prize-redemption kiosks 514A/514B) to scan the ticket 773 and automatically dispense the corresponding cash prize. In any case, upon redemption, mobile scanner 814 is configured to automatically modify the game data 218 to prevent the same pulltab card from being redeemed a second time, as described above.

FIG. 9A is a spreadsheet 974A illustrating a first example set of game data 918A (e.g., game data 218 of FIG. 2) that could be generated by game generator 211 running on computing system 208 and, in some examples, uploaded to the local memory of a prize-redemption device 214 to pair the associated set of pulltab cards 106 with that device, and/or to activate the set of cards for redemption via that device 214. In this example, game data 918A is formatted as a Comma-Separated Values (“.csv”) file with at least four distinct data parameters (i.e., columns) for each entry (i.e., row), wherein each entry/row represents a different winning pulltab card.

In this particular example, column “A” contains the unique game serial number 458 (FIG. 4A) assigned to each pulltab game (i.e., set of pulltab cards), which, in this example, is “888888.” Column “B” contains a “denomination code” 952A (e.g., prize-amount indicator 452 of FIG. 4C), i.e., a monetary value, in units of U.S. dollars, of the cash prize for the winning pulltab card represented by that particular row. For instance, in the value “0001D.pdf,” the number “0001” represents a prize amount of $1, and the letter “D” indicates which game entry 446 (e.g., the fourth game entry 446D concealed underneath the fourth perforated tab 442D) was the winning game entry on the card 336.

Column “C” contains the prize-verification code 954A (e.g., the prize-verification code 454 of FIG. 4C) for a winning pulltab card 336 (which is also encoded by the inner scannable code 456), in order to associate the other three columns with one particular winning card. Finally, column “D” encodes the artwork-template ID 460 (FIG. 4A), which is used by printer 220 (FIG. 2) when printing physical cards 106.

As referenced above, when a winning player 222 collects a cash prize by scanning the inner scannable code 456 on the code scanner 562A/562B/762/862 of an appropriate prize-redemption device 214, the prize-redemption device 214 and or CRM 210 can be configured to automatically store an indication that the associated winning card has been redeemed so that the same prize cannot be collected multiple times. For instance, in some examples, game data 918A can include a fifth column “E” (not shown) that includes a “REDEEMED” indicator or an “UNREDEEMED” indicator for each entry, which the prize-redemption device 214 automatically updates upon redemption. Additionally or alternatively, upon redemption of a winning pulltab card, the prize-redemption device 214 and/or CRM 210 can modify the relevant entry in some way, such as by truncating or deleting the prize-verification code 954A, or even the entire row, such that subsequent queries for the prize-verification code 454 will fail.

FIG. 9B is a spreadsheet 974B illustrating a second example set of game data 918B (e.g., game data 218 of FIG. 2) that could be generated by game generator 211 running on computing system 208, and, in some examples (but not all examples) uploaded to local memory of a prize-redemption device 214 to pair the associated set of pulltab cards 106 with that device and/or to activate the cards for redemption on that device. In this example, game data 918B is formatted as a .csv file with just one single data parameter (i.e., column “A”) for each entry (i.e., row), wherein each entry/row represents a different winning pulltab card.

In the example of FIG. 9B, each entry/row within game data 918B contains the prize-verification code 954B (e.g., prize-verification code 454 of FIG. 4C) encoded by the inner scannable code 456 printed on the respective winning pulltab card. Specifically, each prize-verification code 954A is a fourteen-digit number, wherein: (1) the first six digits (e.g., “888888”) are the game serial number 458; (2) the next four digits are the denomination code 952B (e.g., prize-amount indicator 452 of FIG. 4C) indicating an amount of prize money in units of U.S. dollars; and (3) the last four digits are the winning-ticket ID 955 used to distinguish between individual cards with the same game serial number and the same denomination code.

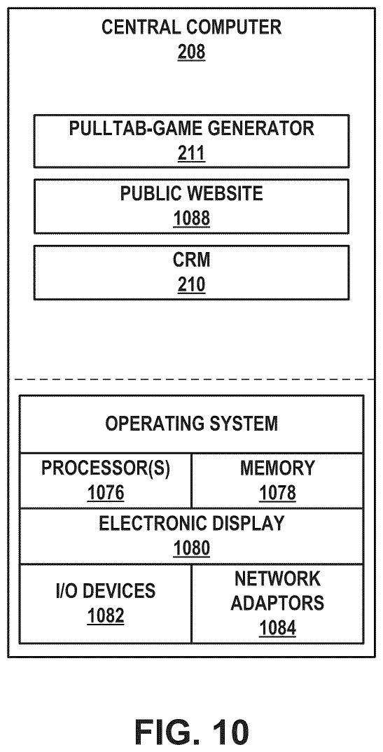

FIG. 10 is a conceptual block diagram of an example implementation of central computer 208 of FIG. 2. Although depicted in FIG. 10 as a single functional unit, in practice, central computer 208 can be, or can include, multiple communicatively-connected computing devices, e.g., each having a unique processor (or “processing circuitry”) 1076 and/or a digital memory 1078. For instance, central computer 208 can be, or can include, a cloud-based server and/or one or more “local” devices. Memory 1078 encodes one or more software applications (“apps” or “modules”) for generating and managing pulltab games for a network of customers or clients, such as hosting establishments 104A-104N of FIG. 1.

For instance, as shown in FIG. 10, central computer 208 is configured to run or execute a pulltab-game generator module 211. When executed, game generator 211 is configured to automatically generate a new pulltab game that includes a set of game data 218 (e.g. a .csv file 974A/974B), and corresponding digital, graphical pulltab-card images 216 (e.g., a .jpg, .bmp, .webp file etc.), each featuring randomized sets of game entries 446 (FIG. 4C).

Central computer 208 is further configured to host (e.g., store in memory 1078) and run (e.g., execute) a public-facing website 1088, accessible via the Internet. Players 222 can access website 1088 with, for instance, a personal computer, laptop, smartphone, smartwatch, or tablet, in order to learn more information about a pulltab game, or in some cases, to enroll in an additional bonus game.

As one example, a winning player 222 can use their smartphone to scan the outer scannable code 444 (FIG. 4B) on the backside 438B of their winning pulltab card 336. The outer scannable code 444 will direct their smartphone's mobile browser to website 1088, where player 222 can enter a “second-chance” drawing to win an additional prize.

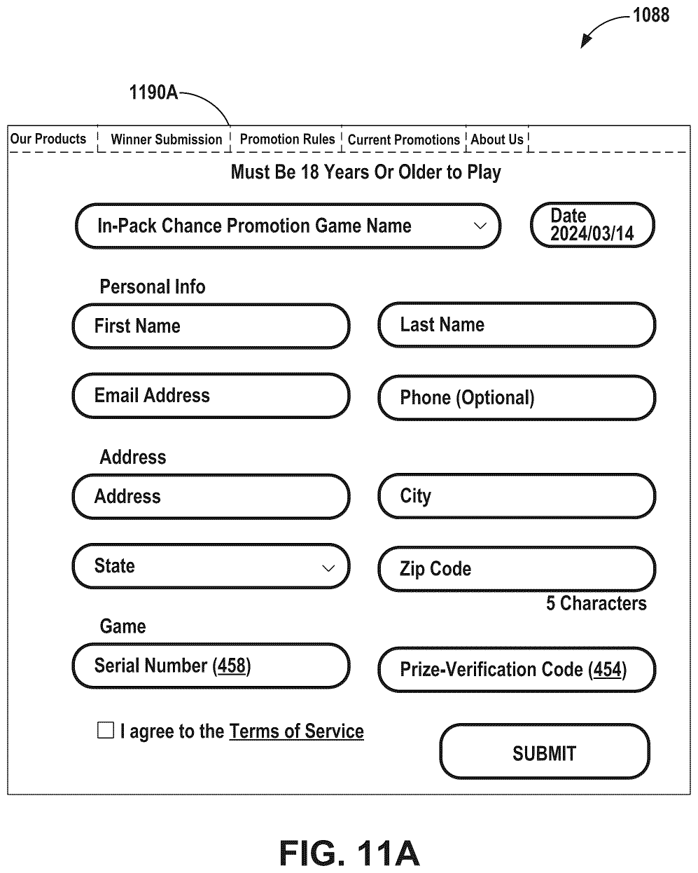

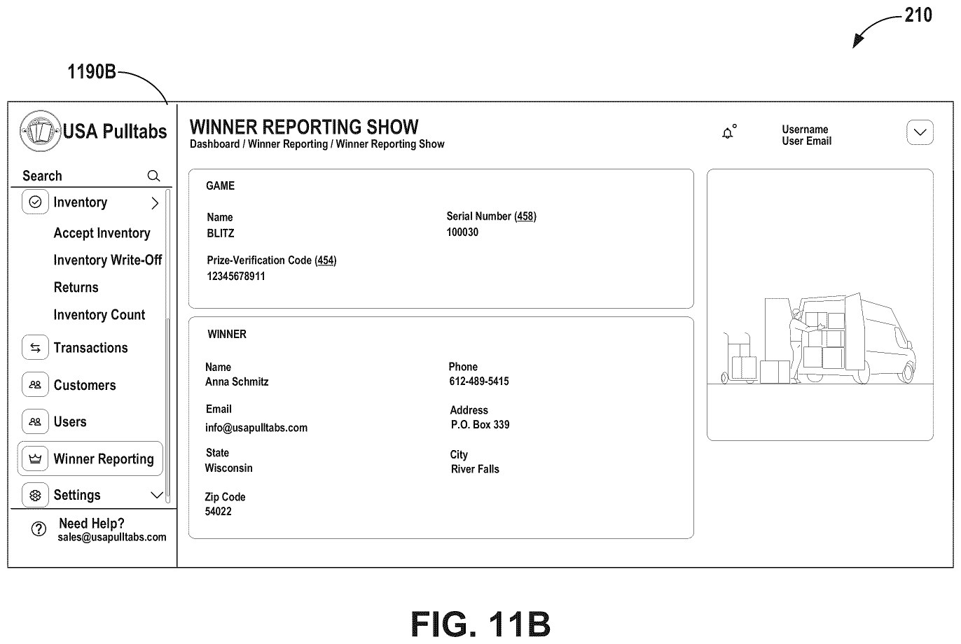

FIG. 11A is a screenshot of an example graphical user interface (GUI) 1190A of public-facing website 1088 of FIG. 10, and FIG. 11B is a screenshot of an example GUI 1190B of a corresponding page of a uniquely tailored Customer-Relationship-Management (CRM) software application 210 run by central computer 208 of FIGS. 2 and 10. As shown in FIG. 11A, GUI 1190A enables a winning player 222 to submit their name, contact info, and the prize-verification code 454 from their winning card 336 in order to be entered into a periodic, randomized “second-chance” drawing to win an additional prize. The drawing can occur weekly, monthly, semi-annually, or annually, as a few illustrative examples.

The public-facing website 1088 is configured to interface with CRM 210. For instance, as shown in FIG. 11B, CRM 210 is configured to receive, via website 1088, the second-chance drawing entry data from winning player 222. Additionally, CRM 210 can retrieve and consult game data 218 in order to verify the winning player's prize-verification code 454 and confirm their entry into the next drawing. Equivalently, game generator 211 can automatically transmit game data 218 to CRM 210 every time it generates a new pulltab game. In some examples, CRM 210 is configured to run all drawing entries through a validation process by matching each player's entry (e.g., game serial number 458, theme name of pulltab game, and prize-verification code 454) with game data 218 stored in memory 1078. If CRM 210 validates a player's entry, the player's entry receives a positive-validation indicator within GUI 1190B, such as by displaying that player's entry in green.

In one non-limiting, illustrative example, CRM 210 can be configured to help run the drawing annually by randomly selecting among all the player entries submitted during the previous calendar year (i.e., January 1^{st} through December 31^{st}). The winner of the drawing can be contacted directly using the player's entry data, and announced publicly on website 1088. Through CRM 210, every drawing entry is assigned a drawing date to help differentiate between different promotions (e.g., subsequent years' drawings).

In some examples, CRM 210 can also use the player's drawing-entry data to keep track of the number of redeemed winning pulltab cards for each game, as they are purchased and opened over time. Such data can help inform pulltab-game inventory management, another function performed by CRM 210. For instance, central game manager(s) 102 (FIG. 1) can use CRM 210 to help decide whether to either increase or decrease the rate at which new pulltab games are automatically generated under a subscription service (rather than on-demand, by purchase order), based on the rate at which winning cards 336 are purchased and redeemed.

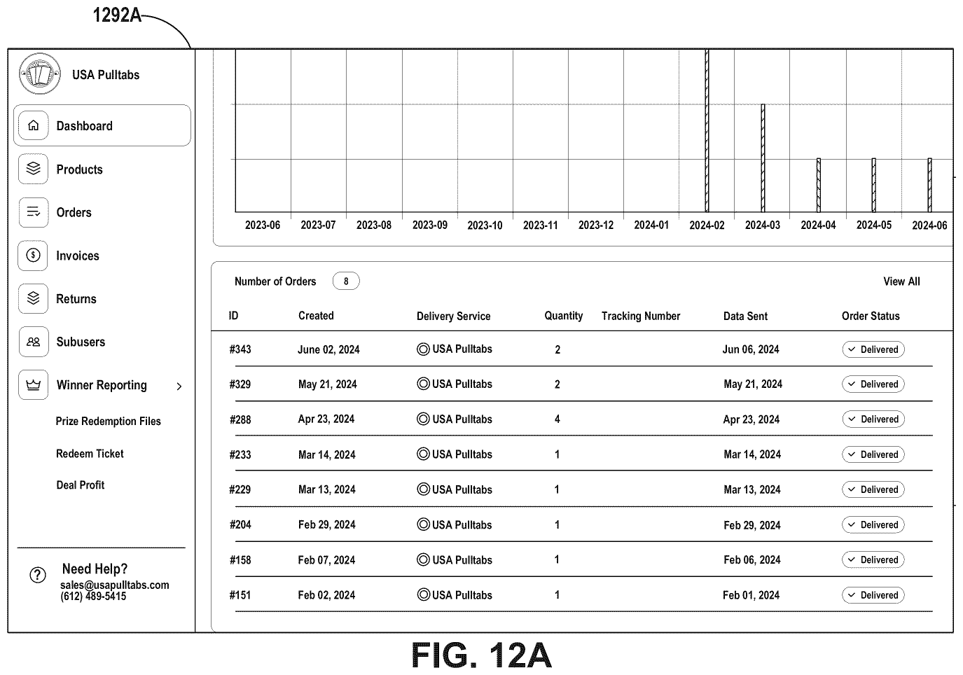

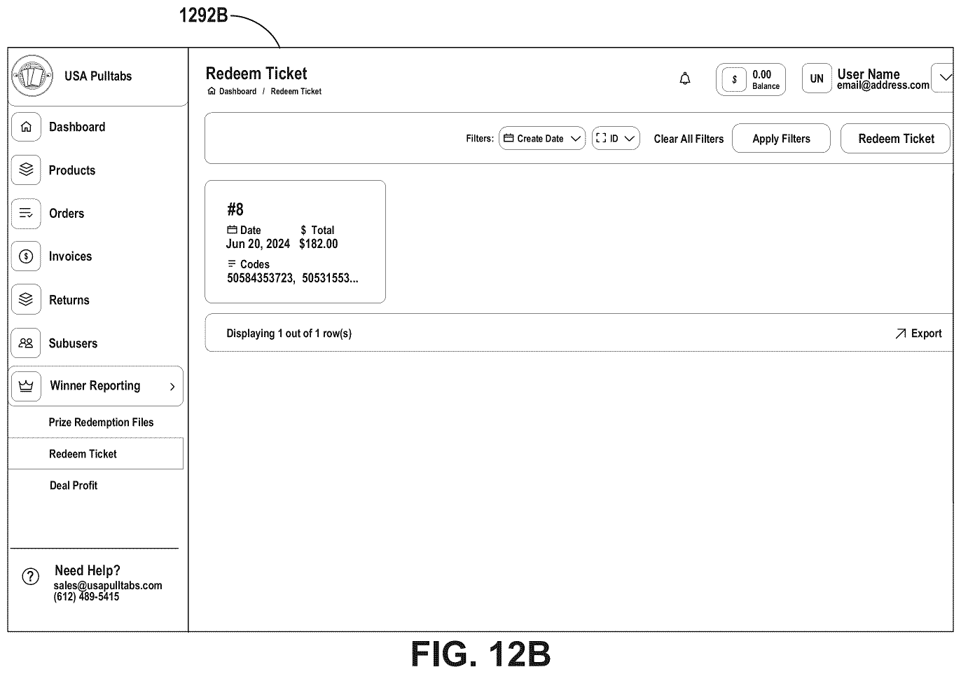

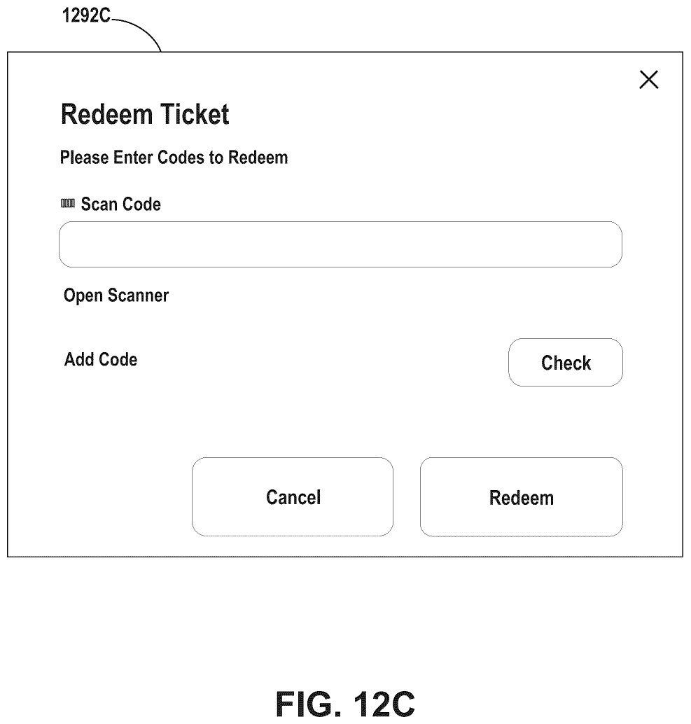

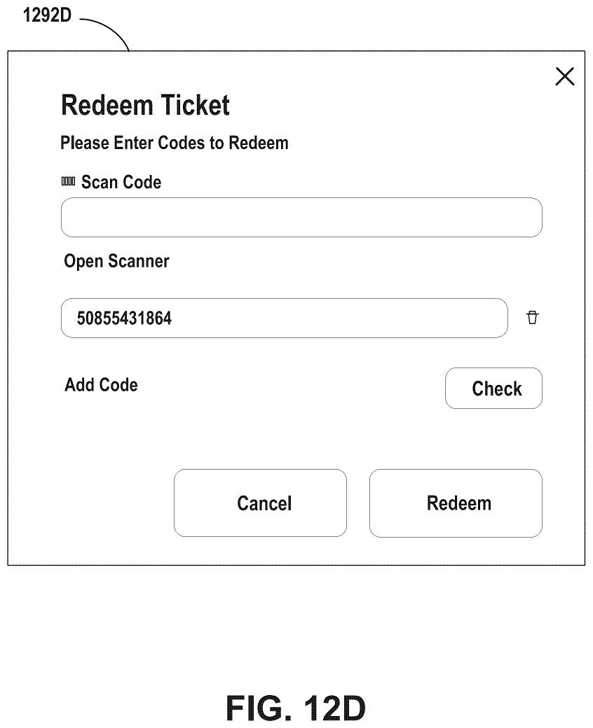

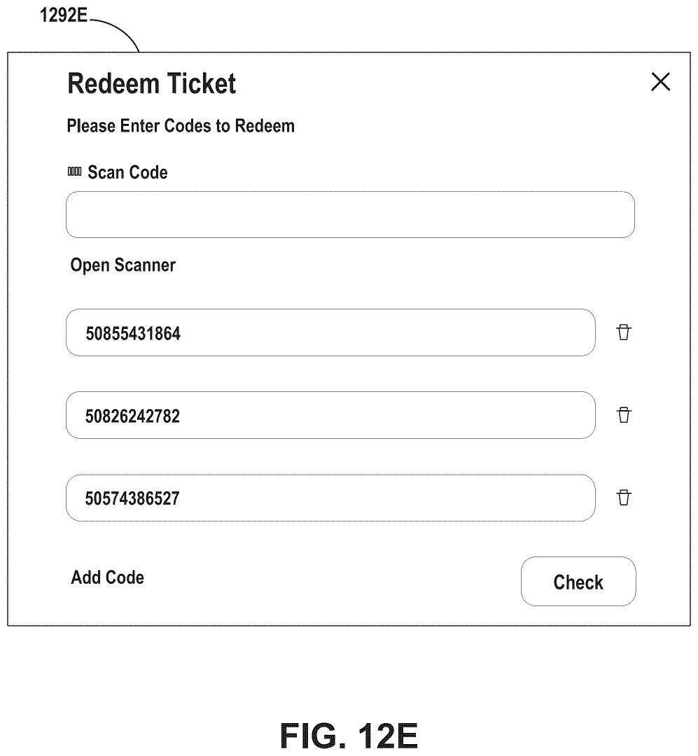

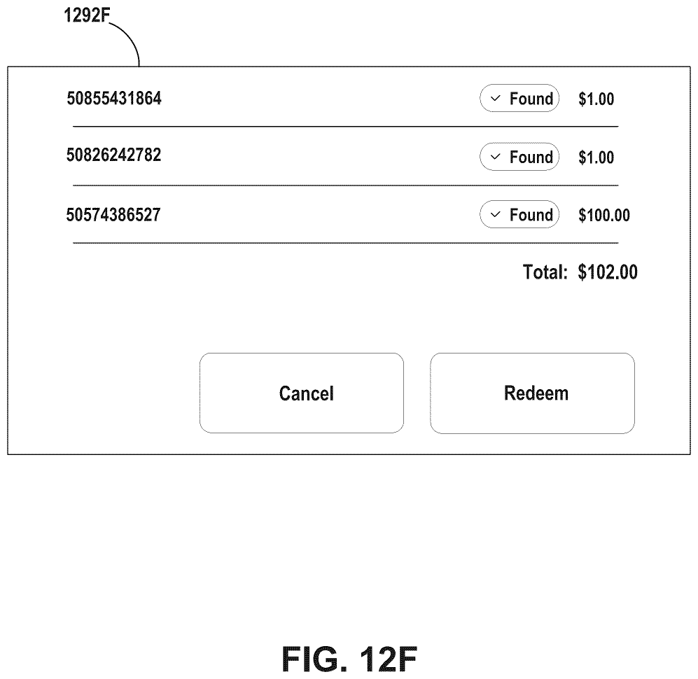

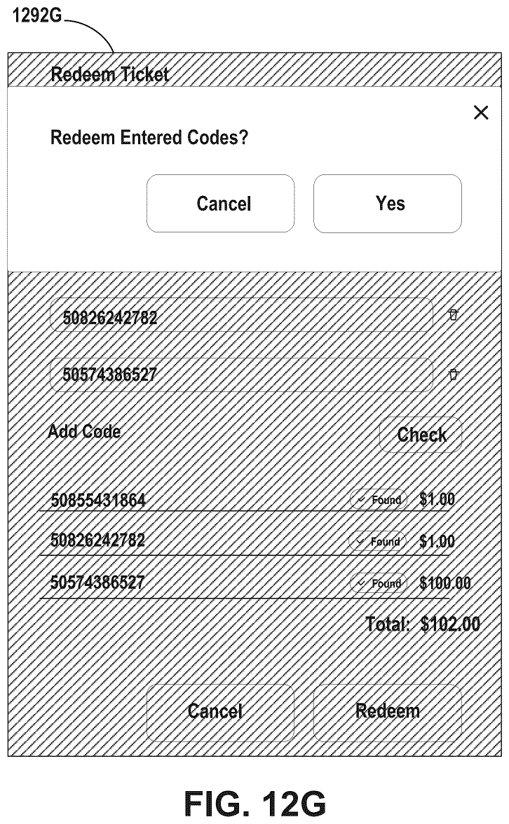

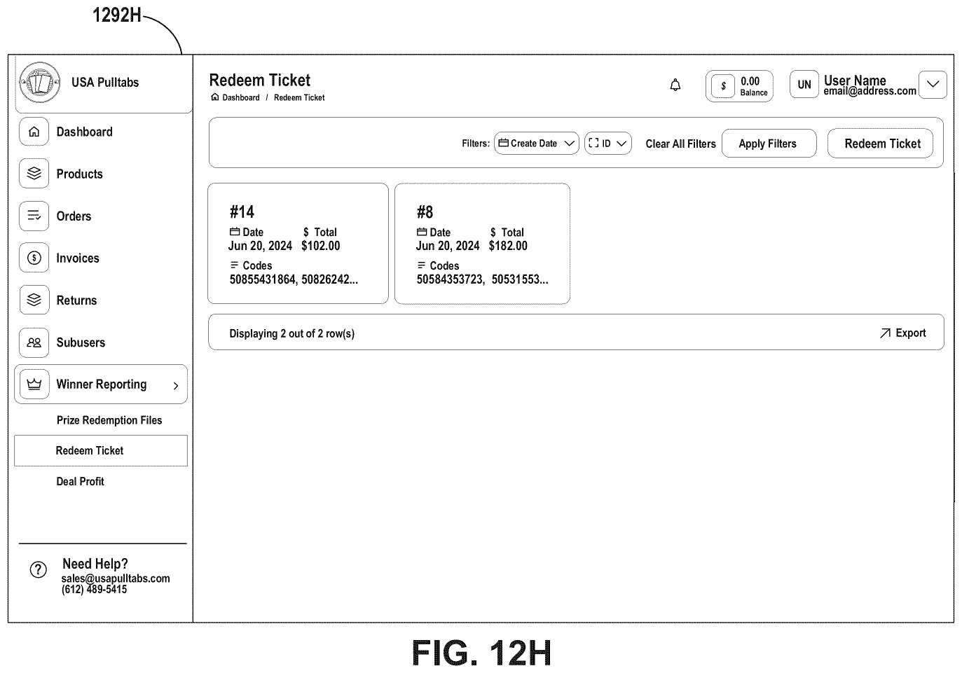

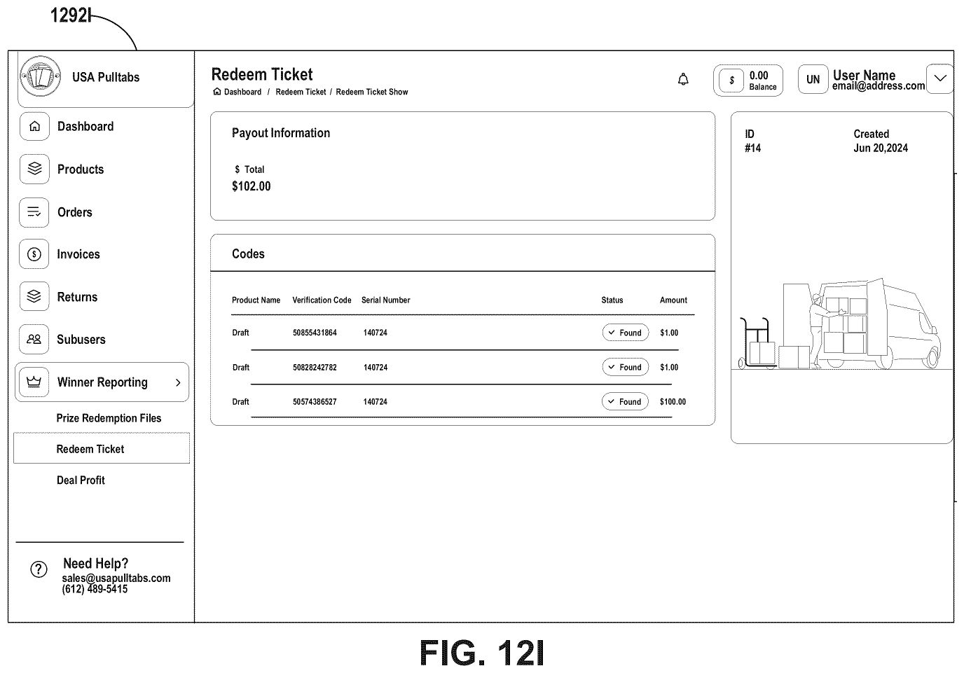

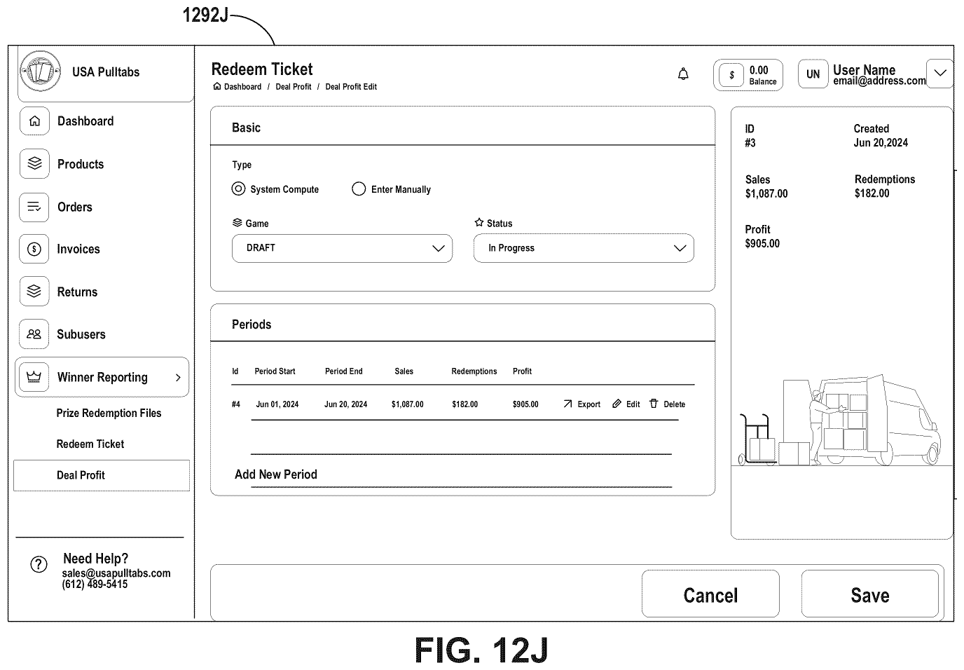

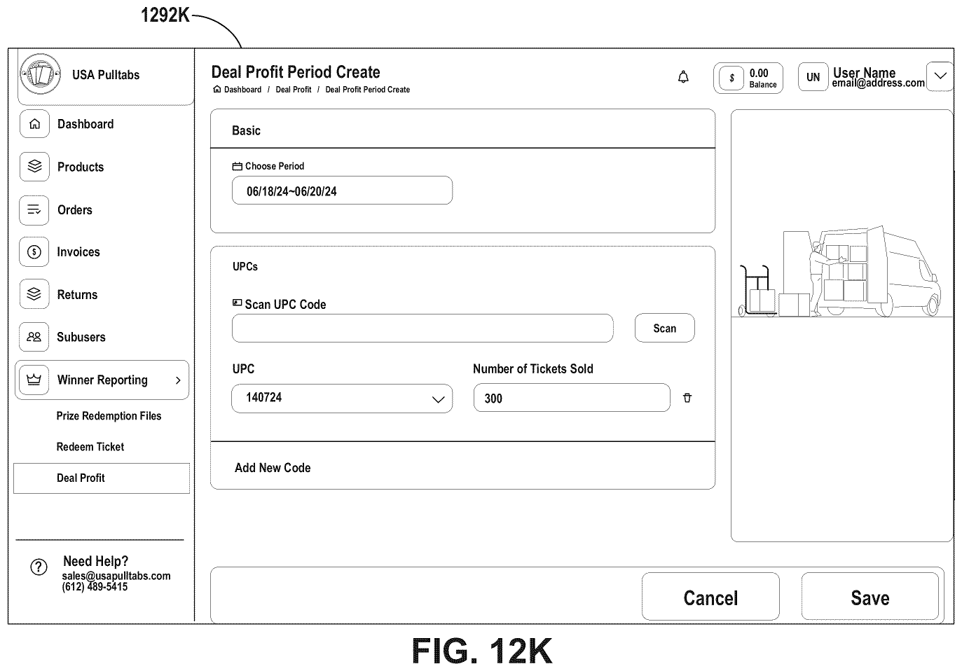

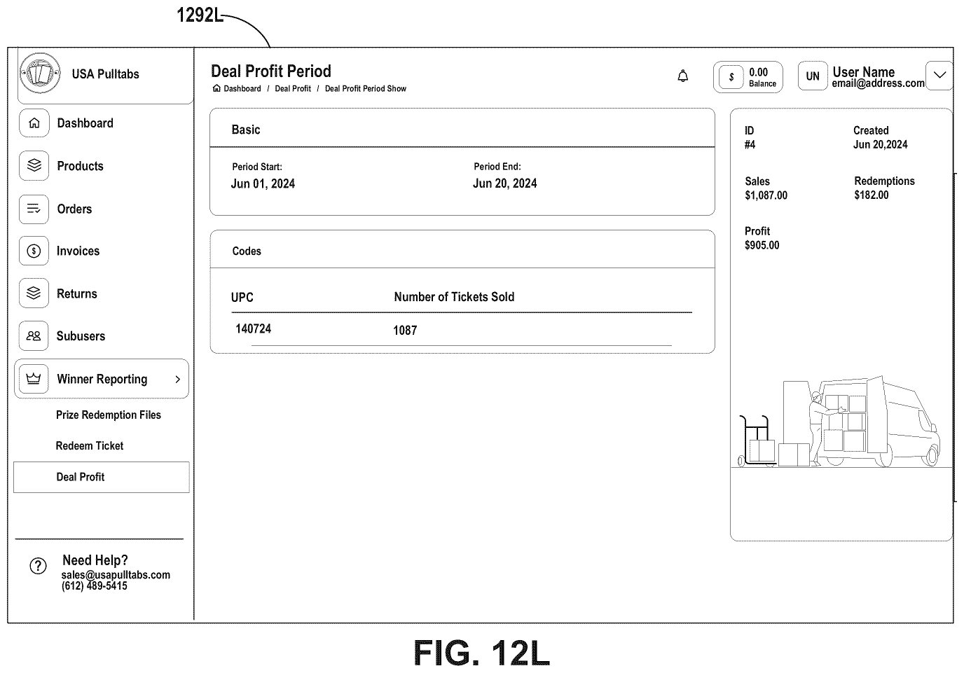

FIGS. 12A-12L are a series of screenshots 1292A-1292L, respectively, showing an example process for how an authorized user (e.g., a game operator 205 associated with a hosting establishment 104/204) with an appropriate prize-redemption device 214 (e.g., POS 714 of FIG. 7 and/or mobile scanner 814 of FIG. 8) can access CRM 210 (via website 1088) to redeem a winning pulltab card 336 on behalf of a player 222. For instance, the operator 205 can open a web browser on the prize-redemption device 214 and use their personalized login credentials to access an instance of CRM 210, an example of which is shown in FIG. 12A. As shown in FIG. 12B, the operator 205 can navigate to “Winner Reporting” and select “Redeem Ticket.” Once the GUI 1292C of FIG. 12C is displayed on the electronic display 764/864, the operator 205 can use the optical scanner 762/862 to scan the scannable code 456 on the winning pulltab card 336 (FIG. 12D), and then select “Check” on the electronic display 764/864 to verify the corresponding prize-verification code 454. In the case of multiple scannable codes, the operator 205 can scan all of the codes prior to selecting “Check” (FIG. 12E) in order to verify the validity of all of the pulltab cards simultaneously (FIG. 12F).

Once the validity of the pulltab cards has been checked, the operator 205 can select “Redeem” in order to redeem the winner(s) and pay out the corresponding cash prize(s) to the player(s) 222, as shown in FIG. 12G. As shown in FIG. 12H, CRM 210 is configured to automatically generate a redemption record for each redeemed pulltab card—that is, the corresponding prize-verification codes 454 will be marked as “redeemed” within the records of CRM 210. In this way, CRM 210 prevents unscrupulous players from attempting to redeem the same winning pulltab card more than once. As shown in FIG. 12I, by selecting “View,” the operator 205 can review additional details for all of the winning pulltab cards redeemed up to that point.

As shown in FIG. 12J, CRM 210 enables the game operator 205 to calculate an amount of profit generated through sales of the pulltab cards for a particular period. For instance, the operator 205 can navigate to “Deal Profit” and select “Add New.” The operator 205 can then select a particular pulltab game for which to record profit. CRM 210 will automatically generate a corresponding profit record, which the operator 205 can then use to periodically record income generated from sales of the cards. That is, CRM 210 enables the operator 205 to determine the amount of profit, either by manually entering prize redemptions (i.e., cash payouts for winning pulltab cards) when the prize-redemption device 214/514A/514B/714/814 verifies the ticket using game data 218 stored in local memory, and/or by computing total prizes redeemed online through CRM 210 via the process shown in FIGS. 12A-12H.

As shown in FIGS. 12K and 12L, the operator 205 can further use CRM 210 to determine the income/profit from pulltab-card sales for a particular period of time. For instance, the operator 205 can select “Add New Period” and then choose a redemption period, input the UPC of the game to display, and then manually enter the number of pulltab cards sold (CRM 210 will then automatically calculate the gross sales as the number of cards sold times the price per card). Upon clicking “Save,” CRM 210 will calculate and display the profit for the selected time period. Through CRM 210, the operator 205 is able to select and view as many profit-and-loss periods as desired—the system will continue aggregating total winning-card redemptions (YTD vs. selected period) and total card sales (YTD vs. selected period) until all of the pulltab cards for the selected game have been sold and/or all of the winning pulltab cards from that game have been redeemed.

FIG. 13 is a screenshot of another example GUI 1392 of CRM 210, showing an implementation of the game-activation links 1394, as described above with respect to FIG. 2. In this example, clicking each game-activation link 1394 either displays or downloads (for subsequent display) a unique, scannable game-activation QR code. The game-activation QR code encodes: (1) a URL or API endpoint; (2) the unique game serial number 458 for each new pulltab game (i.e., for each new set of cards); and (3) an authentication token or other secure credentials. A game operator 205 can use the external scanner 562A/762/862 of a prize-redemption device 214 to scan the game-activation code displayed on their mobile device. The prize-redemption device 214 extracts the URL and credentials from the activation code, and then makes a secure API request to the specified URL to download the game data 218 to a digital memory (e.g., hard drive) within the prize-redemption device 214.

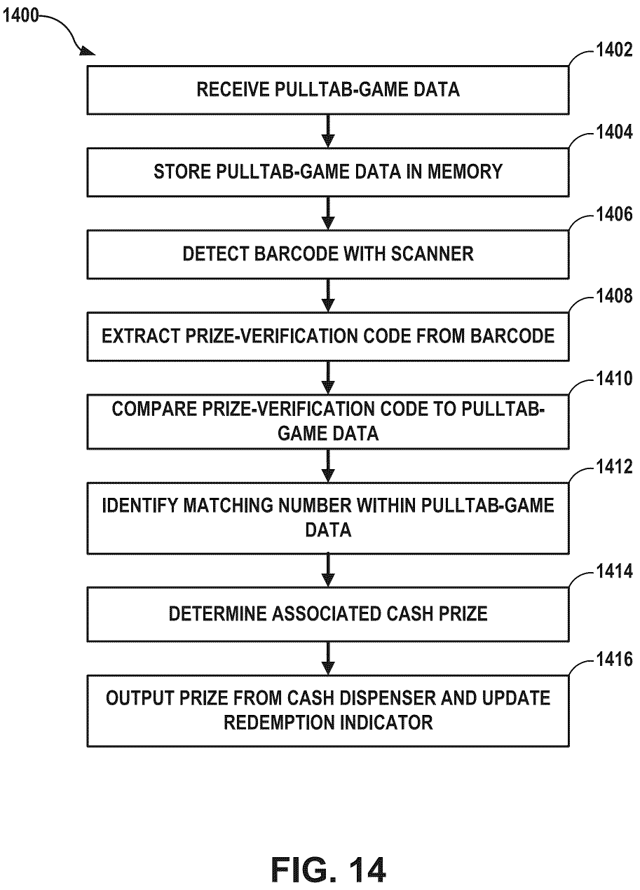

FIG. 14 is a flowchart illustrating a method or process 1400 for automating one or more aspects of a pulltab game. Process 1400 is described from the perspective of prize-redemption kiosk 514A of FIG. 5A.

At Step 1402, prize kiosk 514A receives a set of game data 218 for a new pulltab game, either locally, e.g., from a removable digital storage inserted into the kiosk, or remotely, e.g., via the Internet from a central computer 208. For instance, in a first example, after an order of one or more pulltab games is designated as “delivered” to a particular hosting establishment 204, an authorized game operator 205 associated with the establishment 204 can log in to the CRM software 210 and click an activation link, such as a “Push Game Data to Prize-Redemption Kiosk” button. In response, the CRM software 210 securely transmits game data 218, via an API call, to a digital memory (e.g., hard drive) within the prize-redemption kiosk 514A. Upon receipt of the game data 218 at the kiosk 514A (Step 1404), the operator 205 can then manually “activate” the particular pulltab game via a user interface of the kiosk 514A, thereby ensuring end-user control over the game-activation process.

In a second example, clicking the activation link 1394 (FIG. 13) displays a unique scannable activation code (e.g., QR code) that encodes: (1) a URL or API endpoint; (2) a unique game serial number 458; and (3) an authentication token (or other secure credentials). After an order of one or more pulltab games is designated as “delivered” to a particular hosting establishment 204, the game operator 205 can log in to the CRM software 210 (e.g., on a mobile device) to view the unique QR code, and then scan the QR code using the external optical code scanner 562A of the prize kiosk 514A. The prize kiosk 514A reads the URL and credentials from the QR code, and then makes a secure API request to the specified URL to download the game data 218 to a digital memory (e.g., hard drive) within the prize kiosk 514A. Upon receipt of the game data 218 at the device 514A (Step 1404), the operator 205 can then manually “activate” the particular pulltab game via a user interface of the device 514A, thereby ensuring end-user control over the game-activation process.

At Step 1406, prize kiosk 514A detects a scannable verification code 456, such as a barcode or QR code, printed on a pulltab card 336 placed in front of its integrated optical scanner 562A. Optical scanner 562A scans the code 456, and at Step 1408, extracts the prize-verification code 454 encoded thereby. At Step 1410, prize kiosk 514A compares the prize-verification code 454 to the complete set of prize-verification codes included in game data 218 stored in local memory. At Step 1412, prize kiosk 514A identifies a matching number, and also verifies that prize-verification code 454 has not already been redeemed, thereby confirming that pulltab card 336 is a valid, winning card. In some examples, prize kiosk 514A is further configured to verify that the pulltab card 336 belongs to a gameset that is paired for redemption on this particular kiosk 514A, and not a different prize-redemption device 214 located elsewhere, based on a game serial number associated with the card 336, and/or that the card's gameset was confirmed for active play (or “activated”) by the operator 205.

Upon successfully completing every step of the verification process, at Step 1414, prize kiosk 514A retrieves, from within game data 218, a prize denomination corresponding to prize-verification code 454, and at Step 1416, automatically dispenses a cash prize from prize dispenser 566, in an amount corresponding to the prize denomination. In some examples, prize kiosk 514A also modifies the game data to prevent fraudulent redemption of the same pulltab card in the future.

Although the systems, devices, and methods of the invention have been described in connection with the field of trading cards, card-based games, and chance-based gaming, it can readily be appreciated that the invention is not limited solely to such fields, and can be used in other fields.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the invention or elements thereof may by described in terms of vertical, horizontal, transverse (lateral), longitudinal, and the like, it should be understood that variations from the absolute vertical, horizontal, transverse, and longitudinal are also deemed to be within the scope of the invention.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc., in question is (or is not) removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A non-transitory, computer-readable medium comprising program instructions that, when executed by processing circuitry of a prize-redemption device, cause the processing circuitry to:
receive scan data indicative of a scannable verification code printed on a pulltab card of a pulltab game;
determine, based on the scan data, a prize-verification code for the pulltab card;
verify the pulltab card by:
determining, based on a game serial number associated with the prize-verification code, that the pulltab game is paired with the prize-redemption device or activated for redemption on the prize-redemption device;
determining, based on the prize-verification code, that the pulltab card is a winning card; and
determining, based on the prize-verification code, that the winning card has not already been redeemed; and
in response to verifying the pulltab card, cause the prize-redemption device to dispense a cash prize associated with the winning card or an indication of the cash prize.

2. The non-transitory, computer-readable medium of claim 1, wherein the processing circuitry is configured to determine that the pulltab card is a winning card by comparing the prize-verification code to a set of game data stored in a local memory of the prize-redemption device.

3. The non-transitory, computer-readable medium of claim 2, wherein the game data comprises a comma-separated values (.csv) file comprising, for each of a plurality of winning cards of the pulltab game comprising the winning card:
the game serial number for the pulltab game; and
a denomination code indicating an amount of prize money associated with the winning card.

4. The non-transitory, computer-readable medium of claim 3, wherein the prize-verification code for the pulltab card comprises a fourteen-digit number in which:
a first group of six digits encodes the game serial number
a second group of four digits encodes the denomination code; and
a third group of four digits encodes a winning ticket ID.

5. The non-transitory, computer-readable medium of claim 3, wherein the prize-verification code comprises an eleven-digit numeric code, and wherein the .csv file further comprises the eleven-digit numeric code.

6. The non-transitory, computer-readable medium of claim 2, wherein the processing circuitry is further configured to wirelessly receive the game data from a remote computing system to exclusively pair the game serial number with the prize-redemption device.

7. The non-transitory, computer-readable medium of claim 6, wherein:
the scan data comprises first scan data; and
the processing circuitry is further configured to:
receive second scan data indicative of a quick-response (QR) code generated by the remote computing system;
determine, based on the second scan data, a URL and an authentication code;
transmit an API request comprising the authentication code to the URL; and
in response to transmitting the API request, wirelessly receive the game data.

8. The non-transitory, computer-readable medium of claim 1, wherein, in response to verifying the pulltab card, the processing circuitry is further configured to cause a ticket collector of the prize-redemption device to eject the pulltab card into a secure receptacle of the prize-redemption device.

9. The non-transitory, computer-readable medium of claim 1, wherein, in response to verifying the pulltab card, the processing circuitry is further configured to update a log of prize-redemption transactions stored in digital memory.

10. A method comprising:
wirelessly receiving, by a prize-redemption device from a remote computing system, a set of game data for a pulltab game comprising a plurality of pulltab cards to exclusively pair the pulltab game with the prize-redemption device, wherein the game data comprises:
a game serial number for the pulltab game;
a prize-verification code for each of a plurality of winning cards within the plurality of pulltab cards; and
a denomination code indicating an amount of prize money for each of the plurality of winning cards; and
verifying a winning card from the plurality of winning cards by:
determining, based on the game serial number, that the pulltab game is paired with the prize-redemption device or activated for redemption on the prize-redemption device; and
determining, based on the respective prize-verification code, that the winning card has not already been redeemed.

11. The method of claim 10, wherein wirelessly receiving the game data comprises:
scanning, by an optical scanner of the prize-redemption device, a quick-response (QR) code generated by the remote computing system;
determining, based on the scanned QR code, a URL and an authentication code;
transmitting an API request comprising the authentication code to the URL; and
in response to transmitting the API request, wirelessly receiving the game data.

12. The method of claim 10, further comprising, in response to verifying the winning card, ejecting, by a ticket collector of the prize-redemption device, the winning card into a secure receptacle of the prize-redemption device.

13. The method of claim 10, further comprising, in response to verifying the winning card, updating a log of prize-redemption transactions stored in a digital memory of the prize-redemption device.

14. The method of claim 10, further comprising:
scanning, by the optical scanner, a scannable verification code printed on the winning card; and
determining, by the prize-redemption kiosk based on the scannable verification code, the prize-verification code for the winning card.

15. A system comprising:
a computing device configured to generate a pulltab game comprising:
a set of game data; and
a set of graphical card images comprising at least one scannable verification code associated with the game data; and
a prize-redemption device configured to:
wirelessly receive the game data from the computing device via an API request to exclusively pair the pulltab game with the prize-redemption device;
scan the at least one scannable verification code printed on a pulltab card belonging to the pulltab game to determine a prize-verification code for the pulltab card;
verify the pulltab card as a winning card based on the prize-verification code and the game data; and
dispense a cash prize associated with the pulltab card in response to verifying the pulltab card as the winning card.

16. The system of claim 15, wherein the prize-redemption device is configured to wirelessly receive the game data by:
scanning a quick-response (QR) code generated by the remote computing system;
determining, based on the scanned QR code, a URL and an authentication code;
transmitting an API request comprising the authentication code to the URL; and
wirelessly receiving the game data in response to transmitting the API request.

17. The system of claim 15, wherein the prize-redemption device comprises an integrated ticket collector configured to:
intake the pulltab card;
scan the scannable verification code; and
in response to the prize-redemption device verifying the pulltab card as the winning card, eject the pulltab card into a secure receptacle of the prize-redemption device.

18. The system of claim 15,
wherein the prize-redemption device comprises a non-transitory, computer-readable memory configured to store the game data and a log of prize-redemption transactions; and
wherein the prize-redemption device is further configured to, in response to verifying the pulltab card as the winning card, update the log of prize-redemption transactions.

19. The system of claim 15, wherein the game data comprises, for each of a plurality of winning cards including the winning card:
a game serial number for the pulltab game; and
a denomination code indicating an amount of prize money.

20. The system of claim 15, wherein the prize-redemption device is configured to verify the pulltab card as the winning card by:
determining, based on a game serial number within the game data, that the pulltab game is paired with the prize-redemption device or activated for redemption on the prize-redemption device; and
determining, based on the prize-verification code, that the winning card has not already been redeemed.
